(19) United States
(12) Patent Application Publication
(10) Pub. No.: US 2023/0058100 A1
(43) Pub. Date: Feb. 23, 2023

(54) SECONDARY BATTERY

(71) Applicant: MURATA MANUFACTURING CO., LTD., Kyoto (JP)

(72) Inventors: Ami ONUMA, Kyoto (JP); Atsushi OUKI, Kyoto (JP); Masahiro MIYAMOTO, Kyoto (JP); Takuju HASHIMOTO, Kyoto (JP); Tomomi SAKUMA, Kyoto (JP); Masaki KURATSUKA, Kyoto (JP); Takashige FUJIKAWA, Kyoto (JP); Ryuji SOEDA, Kyoto (JP); Sho TAKAHASHI, Kyoto (JP); Yoshihito AKIYAMA, Kyoto (JP); Yosuke KONO, Kyoto (JP); Takamasa ONO, Kyoto (JP); Shoichi NISHIYAMA, Kyoto (JP); Takeo ASANUMA, Kyoto (JP); Shinji HAYAZAKI, Kyoto (JP)

(21) Appl. No.: 17/970,287

(22) Filed: Oct. 20, 2022

Related U.S. Application Data
(63) Continuation of application No. PCT/JP2021/014725, filed on Apr. 7, 2021.

(30) Foreign Application Priority Data
Apr. 28, 2020 (JP) 2020-078955
Aug. 4, 2020 (JP) 2020-132278

(51) Int. Cl. H01M 4/525; H01M 10/0525; H01M 4/505; H01M 10/0569

(52) U.S. Cl. CPC H01M 4/525; H01M 10/0525; H01M 4/505; H01M 10/0569; H01M 2004/027

(57) ABSTRACT

A secondary battery includes a positive electrode, a negative electrode, and an electrolytic solution. The positive electrode includes a positive electrode active material layer. The positive electrode active material layer includes a lithium-nickel composite oxide of a layered rock-salt type.

### CROSS REFERENCE TO RELATED APPLICATIONS

The present application is a continuation of PCT application no. PCT/JP2021/014725, filed on Apr. 7, 2021, which claims priority to Japanese application nos. JP2020-078955 and JP2020-132278, filed on Apr. 28, 2020 and Aug. 4, 2020, respectively, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery has been considered in various ways.

Specifically, to obtain a superior characteristic such as superior thermal stability, a layer including LiAlO₂ is provided on a surface of a lithium-transition-metal composite oxide particle, and Al derived from LiAlO₂ is present in a solid solution state in the vicinity of the surface of the lithium-transition-metal composite oxide particle.

In addition, to improve a characteristic such as a low-temperature output characteristic, an operating voltage of a negative electrode is 1.2 V or higher versus a lithium reference electrode, and an electrolytic solution includes a carboxylic acid ester such as methyl acetate. To suppress swelling of a secondary battery, a negative electrode includes spinel lithium titanate, and an electrolytic solution includes ethyl acetate. To improve an electrochemical characteristic in a wide temperature range, a negative electrode includes lithium titanate as a negative electrode active material, and an electrolytic solution includes an isocyanate compound. To reduce gas generation in high-temperature use, a negative electrode includes a titanium oxide, and an electrolytic solution includes a dinitrile compound.

### SUMMARY

The present application relates to a secondary battery.

Although consideration has been given in various ways to improve a battery characteristic of a secondary battery, the battery characteristic is not sufficient yet, and there is still room for improvement.

The present technology has been made in view of such an issue, and relates to providing a secondary battery that is able to obtain a superior battery characteristic an embodiment.

A secondary battery according to an embodiment of the present technology includes a positive electrode, a negative electrode, and an electrolytic solution. The positive electrode includes a positive electrode active material layer. The positive electrode active material layer includes a lithium-nickel composite oxide of a layered rock-salt type represented by Formula (1) below. The negative electrode includes a lithium-titanium composite oxide. The electrolytic solution includes a dinitrile compound and a carboxylic acid ester. A ratio of a capacity per unit area of the positive electrode to a capacity per unit area of the negative electrode is greater than or equal to 100% and less than or equal to 120%. According to an analysis of the positive electrode active material layer performed at a surface of the positive electrode active material layer by X-ray photoelectron spectroscopy, a ratio X of an atomic concentration of Al to an atomic concentration of Ni satisfies a condition represented by Expression (2) below. According to an analysis of the positive electrode active material layer performed at an inner part at a depth of 100 nm of the positive electrode active material layer by X-ray photoelectron spectroscopy, a ratio Y of the atomic concentration of Al to the atomic concentration of Ni satisfies a condition represented by Expression (3) below. A ratio Z of the ratio X to the ratio Y satisfies a condition represented by Expression (4) below.

LiₐNi_{1-b-c-d}Co_{b}Al_{c}M_{d}Oₑ (1)

where:
M is at least one of Fe, Mn, Cu, Zn, Cr, V, Ti, Mg, or Zr; and
a, b, c, d, and e satisfy 0.8<a<1.2, 0.06≤b≤0.18, 0.015≤c≤0.05, 0≤d≤0.08, 0<e<3, 0.1≤(b+c+d)≤0.22, and 4.33≤(1−b−c−d)/b≤15.0.

0.30≤X≤0.70 (2)

0.16≤Y≤0.37 (3)

1.30≤Z≤2.52 (4)

Details of a procedure of measuring the ratio of the capacity of the positive electrode to the capacity of the negative electrode and details of a procedure of analyzing the positive electrode active material layer by X-ray photoelectron spectroscopy (a procedure of identifying each of the ratio X, the ratio Y, and the ratio Z) will be described later.

According to the secondary battery of an embodiment of the present technology, the positive electrode (the positive electrode active material layer) includes the lithium-nickel composite oxide of the layered rock-salt type, the negative electrode includes the lithium-titanium composite oxide, and the electrolytic solution includes the dinitrile compound and the carboxylic acid ester. In addition, the above-described condition is satisfied regarding the ratio of the capacity of the positive electrode to the capacity of the negative electrode, and the above-described conditions are satisfied regarding an analysis result (the ratio X, the ratio Y, and the ratio Z) on the positive electrode active material layer obtained by X-ray photoelectron spectroscopy. This makes it possible to obtain a superior battery characteristic.

Note that effects of the present technology are not necessarily limited to those described herein and may include any of a series of suitable in relation to the present technology.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is an enlarged sectional view of a configuration of a positive electrode illustrated in FIG. 2.

FIG. 4 is a block diagram illustrating a configuration of an application example of the secondary battery.

### DETAILED DESCRIPTION

One or more embodiments of the present technology are described below in further detail with reference to the drawings.

A description is given first of a secondary battery according to an embodiment of the present technology.

The secondary battery to be described here is a secondary battery that obtains a battery capacity using insertion and extraction of an electrode reactant, and includes a positive electrode, a negative electrode, and an electrolytic solution which is a liquid electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is greater than an electrochemical capacity per unit area of the positive electrode.

Although not particularly limited in kind, the electrode reactant is specifically a light metal such as an alkali metal or an alkaline earth metal. Examples of the alkali metal include lithium, sodium, and potassium. Examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

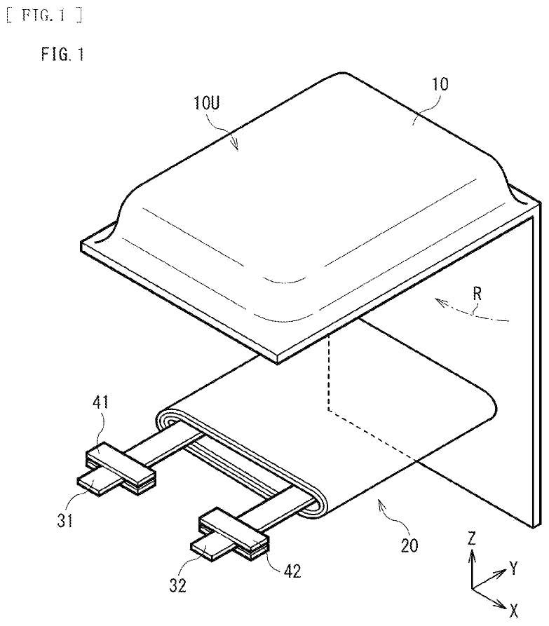

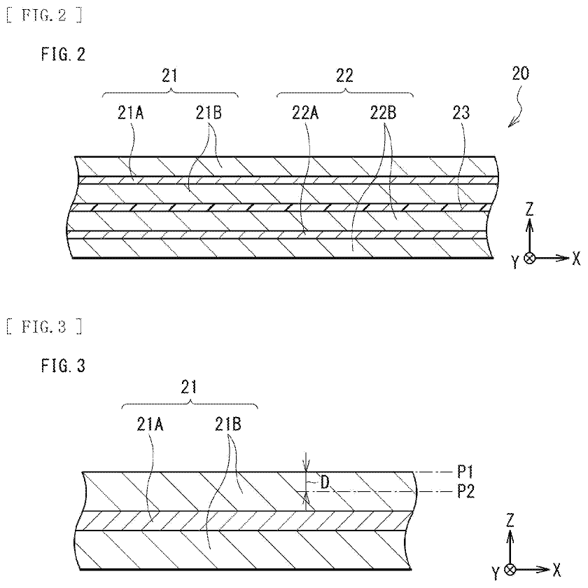

FIG. 1 illustrates a perspective configuration of the secondary battery. FIG. 2 illustrates a sectional configuration of a battery device 20 illustrated in FIG. 1. Note that FIG. 1 illustrates a state in which an outer package film 10 and the battery device 20 are separated away from each other, and FIG. 2 illustrates only a portion of the battery device 20.

As illustrated in FIGS. 1 and 2, the secondary battery includes the outer package film 10, the battery device 20, a positive electrode lead 31, a negative electrode lead 32, and sealing films 41 and 42. The secondary battery described here is a secondary battery of a laminated-film type. The secondary battery of the laminated-film type includes an outer package member having flexibility or softness, that is, the outer package film 10, to contain the battery device 20.

As illustrated in FIG. 1, the outer package film 10 is a flexible outer package member that contains the battery device 20, i.e., for example, a positive electrode 21, a negative electrode 22, and an electrolytic solution to be described later. The outer package film 10 has a pouch-shaped structure.

Here, the outer package film 10 is a single film-shaped member and is foldable in a direction of an arrow R (a dash-dotted line). The outer package film 10 has a depression part 10U to place the battery device 20 therein. The depression part 10U is a so-called deep drawn part.

The outer package film 10 is not particularly limited in configuration (e.g., material and number of layers), and may be a single-layer film or a multi-layer film.

Here, the outer package film 10 is a three-layered laminated film including a fusion-bonding layer, a metal layer, and a surface protective layer that are stacked in this order from an inner side. In a state in which the outer package film 10 is folded, outer edges of the outer package film 10 (the fusion-bonding layer) opposed to each other are bonded or fusion-bonded to each other. As a result, the outer package film 10 has the pouch-shaped structure that allows the battery device 20 to be sealed therein. The fusion-bonding layer includes a polymer compound such as polypropylene. The metal layer includes a metal material such as aluminum. The surface protective layer includes a polymer compound such as nylon.

As illustrated in FIG. 1, the sealing films 41 and 42 are sealing members that each prevent entry of, for example, outside air into the outer package film 10. The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

Specifically, the sealing film 41 includes a polymer compound, such as polyolefin, that has adherence to the positive electrode lead 31. Examples of the polyolefin include polypropylene.

The sealing film 42 has a configuration similar to that of the sealing film 41, except that sealing film 42 has adherence to the negative electrode lead 32. In other words, the sealing film 42 includes a polymer compound, such as polyolefin, that has adherence to the negative electrode lead 32.

As illustrated in FIGS. 1 and 2, the battery device 20 is a power generation device contained inside the outer package film 10, and includes the positive electrode 21, the negative electrode 22, a separator 23, and the electrolytic solution (not illustrated).

Here, the battery device 20 is a so-called wound electrode body. Accordingly, in the battery device 20, the positive electrode 21 and the negative electrode 22 are stacked on each other with the separator 23 interposed therebetween, and the stack of the positive electrode 21, the negative electrode 22, and the separator 23 is wound about a winding axis. The winding axis is a virtual axis extending in a Y-axis direction. In other words, the positive electrode 21 and the negative electrode 22 are wound while being opposed to each other with the separator 23 interposed therebetween.

The battery device 20 has an elongated three-dimensional shape. A section of the battery device 20 intersecting the winding axis described above, that is, a section of the battery device 20 along an XZ plane, accordingly has an elongated shape defined by a major axis and a minor axis. The major axis is a virtual axis that extends in an X-axis direction and has a larger length than the minor axis. The minor axis is a virtual axis that extends in a Z-axis direction intersecting the X-axis direction and has a smaller length than the major axis. Here, the section of the battery device 20 has an elongated, generally elliptical shape.

Here, in the battery device 20, a ratio between a capacity of the positive electrode 21 and a capacity of the negative electrode 22 is optimized. Specifically, a ratio (capacity ratio) CR of a capacity C1 per unit area (mAh/cm²) of the positive electrode 21 to a capacity C2 per unit area (mAh/cm²) of the negative electrode 22 is within a range from 100% to 120% both inclusive. A reason for this is that a high energy density is obtainable. The capacity ratio CR is calculated by CR (%)=(capacity C1/capacity C2)×100.

In a case of determining the capacity ratio CR, the capacities C1 and C2 are each calculated, following which the capacity ratio CR is calculated, by a procedure described below.

First, the secondary battery is disassembled to thereby collect the positive electrode 21 and the negative electrode 22.

Thereafter, a test secondary battery of a coin type is fabricated using the positive electrode 21 as a test electrode and using a lithium metal plate as a counter electrode. The positive electrode 21 includes a lithium-nickel composite oxide as a positive electrode active material, as will be described later.

Thereafter, the test secondary battery is charged and discharged to thereby measure the capacity (mAh) of the positive electrode 21. Upon charging, the secondary battery is charged with a constant current of 0.1 C until a voltage reaches 4.3 V, and is thereafter charged with a constant voltage of that value of 4.3 V until a total charging time reaches 15 hours. Upon discharging, the secondary battery is discharged with a constant current of 0.1 C until the voltage reaches 2.5 V. Note that 0.1 C is a value of a current that causes a battery capacity (a theoretical capacity) to be completely discharged in 10 hours.

Thereafter, the capacity C1 (mAh/cm²) is calculated on the basis of an area (cm²) of the positive electrode 21. The capacity C1 is calculated by C1=capacity of positive electrode 21/area of positive electrode 21.

Thereafter, a test secondary battery of a coin type is fabricated using the negative electrode 22 as a test electrode and using a lithium metal plate as a counter electrode. The negative electrode 22 includes a lithium-titanium composite oxide as a negative electrode active material, as will be described later.

Thereafter, the test secondary battery is charged and discharged to thereby measure the capacity (mAh) of the negative electrode 22. Upon charging, the secondary battery is charged with a constant current of 0.1 C until a voltage reaches 2.7 V, and is thereafter charged with a constant voltage of that value of 2.7 V until the total charging time reaches 15 hours. Upon discharging, the secondary battery is discharged with a constant current of 0.1 C until the battery voltage reaches 1.0 V.

Thereafter, the capacity C2 (mAh/cm²) is calculated on the basis of an area (cm²) of the negative electrode 22. The capacity C2 is calculated by C2=capacity of negative electrode 22/area of negative electrode 22.

Lastly, the capacity ratio CR is calculated on the basis of the capacities C1 and C2. The capacity ratio CR is calculated by CR=(capacity C1/capacity C2)×100, as described above.

The positive electrode 21 includes a positive electrode active material layer 21B, as illustrated in FIG. 2. Here, the positive electrode 21 includes, together with the positive electrode active material layer 21B, a positive electrode current collector 21A that supports the positive electrode active material layer 21B.

The positive electrode current collector 21A has two opposed surfaces each provided with the positive electrode active material layer 21B. The positive electrode current collector 21A includes an electrically conductive material such as a metal material. Examples of the metal material include aluminum.

The positive electrode active material layer 21B includes a positive electrode active material into which lithium is insertable and from which lithium is extractable. Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A on a side where the positive electrode 21 is opposed to the negative electrode 22. The positive electrode active material layer 21B may further include, for example, a positive electrode binder and a positive electrode conductor. A method of forming the positive electrode active material layer 21B is not particularly limited, and specific examples thereof include a coating method.

Specifically, the positive electrode active material layer 21B includes, as the positive electrode active material, one or more of lithium-nickel composite oxides of a layered rock-salt type represented by Formula (1) below. A reason for this is that a high energy density is obtainable.

LiₐNi_{1-b-c-d}Co_{b}Al_{c}M_{d}Oₑ (1)

where:
M is at least one of Fe, Mn, Cu, Zn, Cr, V, Ti, Mg, or Zr; and
a, b, c, d, and e satisfy 0.8<a<1.2, 0.06≤b≤0.18, 0.015≤c≤0.05, 0≤d≤0.08, 0<e<3, 0.1≤(b+c+d)≤0.22, and 4.33≤(1−b−c−d)/b≤15.0.

The lithium-nickel composite oxide is, as is apparent from the conditions related to a to e indicated in Formula (1), a composite oxide including Li, Ni, Co, and Al as constituent elements, and has a layered rock-salt crystal structure. In other words, the lithium-nickel composite oxide includes two transition metal elements (Ni and Co) as constituent elements.

Note that, as is apparent from a possible value range of d (0≤d≤0.08), the lithium-nickel composite oxide may further include an additional element M as a constituent element. The additional element M is not particularly limited in kind, as long as the additional element M includes one or more of Fe, Mn, Cu, Zn, Cr, V, Ti, Mg, or Zr described above.

In particular, as is apparent from a possible value range of (b+c+d), that is, (0.1≤(b+c+d)≤0.22), a possible value range of (1−b−c−d) is 0.78≤(1−b−c−d)<0.9. Accordingly, the lithium-nickel composite oxide includes, as a main component, Ni out of the two transition metal elements (Ni and Co). A reason for this is that a high energy density is obtainable.

As is apparent from a possible value range of (1−b−c−d)/b, that is, (4.33≤(1−b−c−d)/b≤15.0), in the lithium-nickel composite oxide including the two transition metal elements (Ni and Co) as constituent elements, a molar ratio (1−b−c−d) of Ni is sufficiently large with respect to a molar ratio (b) of Co. In other words, a ratio of the molar ratio of Ni to the molar ratio of Co (an NC ratio=(1−b−c−d)/b) is sufficiently large within an appropriate range. A reason for this is that, while the energy density is secured, the discharge capacity is prevented from easily decreasing even upon repeated charging and discharging. Note that the value of the NC ratio is rounded off to two decimal places.

Here, because a molar ratio (d) of the additional element M satisfies d≥0, the lithium-nickel composite oxide may include the additional element M as a constituent element, or may not include the additional element M as a constituent element. In particular, it is preferable that d satisfy d>0 and accordingly the lithium-nickel composite oxide include the additional element M as a constituent element. A reason for this is that it becomes easier for lithium ions to smoothly enter and exit the positive electrode active material (the lithium-nickel composite oxide) at the time of charging and discharging.

A specific composition of the lithium-nickel composite oxide is not particularly limited as long as the conditions indicated in Formula (1) are satisfied. The specific composition of the lithium-nickel composite oxide will be described in detail in Examples below.

The positive electrode active material may further include, together with the lithium-nickel composite oxide described above, one or more of other substances into which lithium is insertable and from which lithium is extractable. The other substance is not particularly limited in kind, and specific examples thereof include a lithium compound. Note that the lithium-nickel composite oxide described already is excluded from the lithium compound described here.

The term “lithium compound” is a generic term for a compound including lithium as a constituent element. More specifically, the lithium compound is a compound including lithium and one or more transition metal elements as constituent elements. The lithium compound is not particularly limited in kind, and is specifically, for example, an oxide, a phosphoric acid compound, a silicic acid compound, or a boric acid compound. Specific examples of the oxide include LiNiO₂, LiCoO₂, and LiMn₂O₄. Specific examples of the phosphoric acid compound include LiFePO₄ and LiMnPO₄.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

Here, regarding a physical property of the positive electrode 21 (the positive electrode active material layer 21B) including the positive electrode active material (the lithium-nickel composite oxide), predetermined physical property conditions are satisfied to improve a battery characteristic of the secondary battery. Details of the physical property conditions will be described later.

The negative electrode 22 includes a negative electrode current collector 22A and a negative electrode active material layer 22B, as illustrated in FIG. 2.

The negative electrode current collector 22A has two opposed surfaces each provided with the negative electrode active material layer 22B. The negative electrode current collector 22A includes an electrically conductive material such as a metal material. Examples of the metal material include copper.

The negative electrode active material layer 22B includes one or more of negative electrode active materials into which lithium is insertable and from which lithium is extractable. Here, the negative electrode active material layer 22B is disposed on each of the two opposed surfaces of the negative electrode current collector 22A. Note that the negative electrode active material layer 22B may be provided only on one of the two opposed surfaces of the negative electrode current collector 22A on a side where the negative electrode 22 is opposed to the positive electrode 21. The negative electrode active material layer 22B may further include, for example, a negative electrode binder and a negative electrode conductor. Details of each of the negative electrode binder and the negative electrode conductor are similar to details of each of the positive electrode binder and the positive electrode conductor. A method of forming the negative electrode active material layer 22B is not particularly limited, and specific examples thereof include one or more of a coating method, a vapor-phase method, a liquid-phase method, a thermal spraying method, and a firing (sintering) method.

Specifically, the negative electrode active material layer includes one or more of lithium-titanium composite oxides as the negative electrode active material. The term “lithium-titanium composite oxide” is a generic term for an oxide including lithium and titanium as constituent elements, as described above. The lithium-titanium composite oxide has a spinel crystal structure. A reason why the negative electrode active material layer includes the lithium-titanium composite oxide is that a decomposition reaction of the electrolytic solution in the negative electrode 22 is suppressed, and thus gas generation due to the decomposition reaction of the electrolytic solution is also suppressed.

The lithium-titanium composite oxide is not particularly limited in kind or configuration, as long as the oxide includes lithium and titanium as constituent elements. Specifically, the lithium-titanium composite oxide includes lithium, titanium, and another element as constituent elements. The other element includes one or more of elements (excluding titanium) belonging to groups 2 to 15 in the long period periodic table of elements. Note that an oxide including nickel together with lithium and titanium as constituent elements shall be classified as the lithium-titanium composite oxide, not as the lithium-nickel composite oxide.

More specifically, the lithium-titanium composite oxide includes one or more of a compound represented by Formula (5) below, a compound represented by Formula (6) below, or a compound represented by Formula (7) below. M1 in Formula (5) is a metal element that is to be a divalent ion. M2 in Formula (6) is a metal element that is to be a trivalent ion. M3 in Formula (7) is a metal element that is to be a tetravalent ion. A reason for this is that a decomposition reaction of the electrolytic solution in the negative electrode 22 is sufficiently suppressed, and thus gas generation due to the decomposition reaction of the electrolytic solution is also sufficiently suppressed.

Li[LiₓM1_{(1-3x)/2}Ti_{(3+x)/2}]O₄ (5)

where:
M1 is at least one of Mg, Ca, Cu, Zn, or Sr; and
x satisfies 0≤x≤1/3.

Li[Li_{y}M2_{1-3y}Ti_{1+2y}]O₄ (6)

where:
M2 is at least one of Al, Sc, Cr, Mn, Fe, Ga, or Y; and
y satisfies 0≤y≤1/3.

Li[Li_{1/3}M3_{z}Ti_{(5/3)-z}]O₄ (7)

where:
M3 is at least one of V, Zr, or Nb; and
z satisfies 0≤z≤2/3.

As is apparent from a possible value range of x in Formula (5), the lithium-titanium composite oxide represented by Formula (5) may include the other element (M1) as a constituent element, or may not include the other element (M1) as a constituent element. As is apparent from a possible value range of y in Formula (6), the lithium-titanium composite oxide represented by Formula (6) may include the other element (M2) as a constituent element, or may not include the other element (M2) as a constituent element. As is apparent from a possible value range of z in Formula (7), the lithium-titanium composite oxide represented by Formula (7) may include the other element (M3) as a constituent element, or may not include the other element (M3) as a constituent element.

Specific examples of the lithium-titanium composite oxide represented by Formula (5) include Li_{3.75}Ti_{4.875}Mg_{0.375}O₁₂. Specific examples of the lithium-titanium composite oxide represented by Formula (6) include LiCrTiO₄. Specific examples of the lithium-titanium composite oxide represented by Formula (7) include Li₄Ti₅O₁₂ and Li₄Ti_{4.95}Nb_{0.05}O₁₂.

The negative electrode active material may further include one or more of other substances into which lithium is insertable and from which lithium is extractable, as long as the negative electrode active material includes the lithium-titanium composite oxide described above. The other substance is not particularly limited in kind, and specific examples thereof include a carbon material and a metal-based material. Note that the lithium-titanium composite oxide described already is excluded from the metal-based material described here.

Examples of the carbon material include graphitizable carbon, non-graphitizable carbon, and graphite. Examples of the graphite include natural graphite and artificial graphite. The metal-based material is a material that includes one or more elements among metal elements and metalloid elements that are each able to form an alloy with lithium. The metal element and the metalloid element are not particularly limited in kind, and specific examples thereof include silicon and tin. The metal-based material may be a simple substance, an alloy, a compound, a mixture of two or more thereof, or a material including two or more phases thereof.

Specific examples of the metal-based material include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≤2), LiSiO, SnO_{w} (0<w≤2), SnSiO₃, LiSnO, and Mg₂Sn. Note that v of SiOᵥ may satisfy 0.2<v<1.4.

In a case of fabricating each of the positive electrode 21 and the negative electrode 22, it is possible to adjust the capacity ratio CR by changing a relationship between an amount of the positive electrode active material and an amount of the negative electrode active material. More specifically, in a process of fabricating each of the positive electrode 21 and the negative electrode 22, it is possible to adjust the capacity ratio CR by changing a thickness of the negative electrode active material layer 22B while fixing a thickness of the positive electrode active material layer 21B.

The “thickness of the negative electrode active material layer 22B” described here is the total thickness of the negative electrode active material layer 22B. Accordingly, in a case where the negative electrode 22 includes two negative electrode active material layers 22B because the negative electrode active material layer 22B is provided on each of the two opposed surfaces of the negative electrode current collector 22A, the thickness of the negative electrode active material layer 22B is the sum of a thickness of one of the negative electrode active material layers 22B and a thickness of the other of the negative electrode active material layers 22B.

In this case, the capacity ratio CR is within the range from 100% to 120% both inclusive, as described above. Thus, even if the thickness of the negative electrode active material layer 22B is small, a decomposition reaction of the electrolytic solution is suppressed, which suppresses gas generation due to the decomposition reaction of the electrolytic solution, as will be described later. Although not particularly limited, the thickness of the negative electrode active material layer 22B is specifically 130 μm or less.

The separator 23 is an insulating porous film interposed between the positive electrode 21 and the negative electrode 22 as illustrated in FIG. 2, and allows lithium ions to pass therethrough while preventing contact or a short circuit between the positive electrode 21 and the negative electrode 22. The separator 23 includes a polymer compound such as polyethylene.

The positive electrode 21, the negative electrode 22, and the separator 23 are each impregnated with the electrolytic solution. The electrolytic solution includes a solvent and an electrolyte salt.

The solvent includes one or more of non-aqueous solvents (organic solvents). An electrolytic solution including a non-aqueous solvent is a so-called non-aqueous electrolytic solution. Specifically, the non-aqueous solvent includes a dinitrile compound and a carboxylic acid ester.

The dinitrile compound is a chain compound having a nitrile group (—CN) at each end, thus including two nitrile groups. The dinitrile compound serves to improve oxidation resistance of the carboxylic acid ester by being used in combination with the carboxylic acid ester.

Although not particularly limited in kind, the dinitrile compound is specifically a compound in which two nitrile groups are bonded to each other via a straight-chain alkylene group. Specific examples of the dinitrile compound include malononitrile (carbon number=1), succinonitrile (carbon number=2), glutaronitrile (carbon number=3), adiponitrile (carbon number=4), pimelonitrile (carbon number=5), and suberonitrile (carbon number=6). The carbon number described above in the parenthesis is a carbon number of the alkylene group.

In particular, the carbon number of the alkylene group is preferably within a range from 2 to 4 both inclusive. Accordingly, the dinitrile compound preferably includes one or more of succinonitrile, glutaronitrile, or adiponitrile. A reason for this is that, for example, solubility and compatibility of the dinitrile compound improve, and the dinitrile compound sufficiently improves the oxidation resistance of the carboxylic acid ester.

The carboxylic acid ester is a straight-chain saturated fatty acid ester. Specific examples of the carboxylic acid ester include methyl acetate, ethyl acetate, methyl propionate, ethyl propionate, propyl propionate, and ethyl trimethylacetate.

In particular, the carboxylic acid ester preferably includes ethyl propionate, propyl propionate, or both. A reason for this is that a decomposition reaction of the carboxylic acid ester is sufficiently suppressed upon charging and discharging, and thus gas generation due to the decomposition reaction of the carboxylic acid ester is also sufficiently suppressed.

Note that a content of the dinitrile compound is set to fall within a predetermined range with respect to a content of the carboxylic acid ester. Specifically, a ratio (molar ratio) MR of a number of moles R1 of the dinitrile compound to a number of moles R2 of the carboxylic acid ester is within a range from 1% to 4% both inclusive. A reason for this is that the content of the dinitrile compound is optimized with respect to the content of the carboxylic acid ester. Thus, even if the dinitrile compound and the carboxylic acid ester are used in combination, a decomposition reaction of the carboxylic acid ester is suppressed, and thus gas generation due to the decomposition reaction of the carboxylic acid ester is also suppressed. The molar ratio MR is calculated by MR (%)=(number of moles R1/number of moles R2)×100.

Although not particularly limited, the content of the carboxylic acid ester in the solvent is preferably within a range from 50 wt % to 90 wt % both inclusive in particular. A reason for this is that a decomposition reaction of the carboxylic acid ester is sufficiently suppressed upon charging and discharging, and thus gas generation due to the decomposition reaction of the carboxylic acid ester is also sufficiently suppressed.

The solvent may further include one or more of other substances, as long as the solvent includes the dinitrile compound and the carboxylic acid ester described above.

The other substance is not particularly limited in kind, and specific examples thereof include esters and ethers. More specific examples of the other substance include a carbonic-acid-ester-based compound and a lactone-based compound. A reason for this is that a dissociation property of the electrolyte salt improves and a high mobility of ions is obtainable.

Examples of the carbonic-acid-ester-based compound include a cyclic carbonic acid ester and a chain carbonic acid ester. Specific examples of the cyclic carbonic acid ester include ethylene carbonate and propylene carbonate. Specific examples of the chain carbonic acid ester include dimethyl carbonate, diethyl carbonate, and methyl ethyl carbonate.

Examples of the lactone-based compound include a lactone. Specific examples of the lactone include γ-butyrolactone and γ-valerolactone. Note that examples of the ethers other than the lactone-based compounds described above may include 1,2-dimethoxyethane, tetrahydrofuran, 1,3-dioxolane, and 1,4-dioxane.

Additional examples of the other substance may include an unsaturated cyclic carbonic acid ester, a halogenated carbonic acid ester, a sulfonic acid ester, a phosphoric acid ester, an acid anhydride, a mononitrile compound, and an isocyanate compound. A reason for this is that chemical stability of the electrolytic solution improves.

The electrolyte salt includes one or more of light metal salts including, without limitation, a lithium salt. Examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium difluoro(oxalato)borate (LiBF₂(C₂O₄)), and lithium bis(oxalato)borate (LiB(C₂O₄)₂).

Although not particularly limited, a content of the electrolyte salt is specifically within a range from 0.3 mol/kg to 3.0 mol/kg both inclusive with respect to the solvent. A reason for this is that a high ionic conductivity is obtainable.

A procedure of determining a composition of the electrolytic solution, including the molar ratio MR and the content of the carboxylic acid ester in the solvent, is as described below.

In a case of examining a composition of a component (the solvent) included in the electrolytic solution, the electrolytic solution is analyzed by one or more of methods including, without limitation, gas chromatography and high-performance liquid gas chromatography. Thus, for example, the kind of the solvent included in the electrolytic solution is identified.

In a case of examining a content of the component (the solvent) included in the electrolytic solution, first, the secondary battery is disassembled to thereby collect the battery device 20, following which the electrolytic solution is collected from the battery device 20. The electrolytic solution is used as a reference solution in a later process. Thereafter, the battery device 20 from which the electrolytic solution has not been collected is immersed in an organic solvent (dimethyl carbonate) for an immersion time of 24 hours. Thus, the electrolytic solution with which the battery device 20 is impregnated is extracted into the organic solvent. As a result, an electrolytic solution extract is obtained. Lastly, the electrolytic solution extract is analyzed by the gas chromatography. In this case, the electrolytic solution collected in the earlier process is used as the reference solution. In addition, a peak area of each component (each solvent included in the electrolytic solution extract) is normalized with reference to a peak area of propylene carbonate to thereby identify a remaining amount of each component. Thus, the content of the solvent included in the electrolytic solution is identified.

In a case of examining the content of the carboxylic acid ester in the solvent, the content of the carboxylic acid ester is calculated on the basis of the content of the solvent included in the electrolytic solution described above. The content of the carboxylic acid ester is calculated by: content of carboxylic acid ester (wt %)=(weight of carboxylic acid ester/weight of solvent)×100. The “weight of solvent” is the sum of weights of all solvents included in the electrolytic solution.

In a case of examining the molar ratio MR, the number of moles R1 of the carboxylic acid ester and the number of moles R2 of the dinitrile compound are identified on the basis of the content of the solvent (the dinitrile compound and the carboxylic acid ester) included in the electrolytic solution described above, following which the molar ratio MR is calculated on the basis of the number of moles R1 and the number of moles R2.

As illustrated in FIG. 1, the positive electrode lead 31 is a positive electrode terminal coupled to the battery device 20 (the positive electrode 21), and is led out from inside to outside the outer package film 10. The positive electrode lead 31 includes an electrically conductive material such as aluminum. The positive electrode lead 31 has a shape such as a thin plate shape or a meshed shape.

As illustrated in FIG. 1, the negative electrode lead 32 is a negative electrode terminal coupled to the battery device 20 (the negative electrode 22). Here, the negative electrode lead 32 is led out from inside to outside the outer package film 10 toward a direction similar to that of the positive electrode 21. The negative electrode lead 32 includes an electrically conductive material such as copper. Details of a shape of the negative electrode lead 32 are similar to those of the shape of the positive electrode lead 31.

In the secondary battery, to improve the battery characteristic, the predetermined physical property conditions are satisfied regarding the physical property of the positive electrode 21 (the positive electrode active material layer 21B) including the positive electrode active material (the lithium-nickel composite oxide), as described above.

Specifically, all of three conditions, i.e., physical property conditions 1 to 3, described below are satisfied regarding an analysis result on the positive electrode active material layer 21B obtained by X-ray photoelectron spectroscopy (XPS), that is, regarding the physical property of the positive electrode active material layer 21B.

Here, a description is given of a premise for describing the physical property conditions 1 to 3, prior to describing the physical property conditions 1 to 3 individually.

FIG. 3 illustrates an enlarged sectional configuration of the positive electrode 21 illustrated in FIG. 2. Positions P1 and P2 illustrated in FIG. 3 represent two analysis positions in a case of analyzing the positive electrode active material layer 21B by XPS. The position P1 is a position of a surface of the positive electrode active material layer 21B, where the positive electrode active material layer 21B is viewed from the surface in a depth direction (the Z-axis direction). The position P2 is a position of an inner part of the positive electrode active material layer 21B, where the positive electrode active material layer 21B is viewed from the surface in the same direction. More specifically, the position P2 is a position (at a depth D of 100 nm) where the depth D from the surface of the positive electrode active material layer 21B is 100 nm.

As described above, the positive electrode active material layer 21B includes the lithium-nickel composite oxide of the layered rock-salt type as the positive electrode active material, and the lithium-nickel composite oxide includes Ni and Al as constituent elements.

In this case, if the positive electrode active material layer 21B is analyzed by XPS, two XPS spectra, i.e., a Ni2p3/2 spectrum and an Al2s spectrum, are detected as result of the analysis. The Ni2p3/2 spectrum is an XPS spectrum derived from Ni atoms in the lithium-nickel composite oxide, and the Al2s spectrum is an XPS spectrum derived from Al atoms in the lithium-nickel composite oxide.

In this manner, an atomic concentration (at %) of Ni is calculated on the basis of a spectrum intensity of the Ni2p3/2 spectrum, and an atomic concentration (at %) of Al is calculated on the basis of a spectrum intensity of the Al2s spectrum.

### (Physical Property Condition 1)

According to an analysis of the positive electrode active material layer 21B performed at the surface (the position P1) of the positive electrode active material layer 21B by XPS, a concentration ratio X which is a ratio of the atomic concentration of Al to the atomic concentration of Ni (=atomic concentration of Al/atomic concentration of Ni) satisfies a condition represented by Expression (2) below.

0.30≤X≤0.70 (2)

The concentration ratio X is a parameter indicating a magnitude relationship between an abundance of Ni atoms and an abundance of Al atoms at the position P1. As is apparent from the condition indicated in Expression (2), the abundance of Al atoms is appropriately smaller than the abundance of Ni atoms at the surface (the position P1) of the positive electrode active material layer 21B.

### (Physical Property Condition 2)

According to an analysis of the positive electrode active material layer 21B performed at the inner part (the position P2) of the positive electrode active material layer 21B by XPS, a concentration ratio Y which is a ratio of the atomic concentration of Al to the atomic concentration of Ni (=atomic concentration of Al/atomic concentration of Ni) satisfies a condition represented by Expression (3) below.

0.16≤Y≤0.37 (3)

The concentration ratio Y is a parameter indicating a magnitude relationship between the abundance of Ni atoms and the abundance of Al atoms at the position P2. As is apparent from the condition indicated in Expression (3), the abundance of Al atoms is appropriately smaller than the abundance of Ni atoms at the inner part (the position P2) of the positive electrode active material layer 21B. Note that, as is apparent from comparison between the physical property conditions 1 and 2, the abundance of Al atoms is appropriately larger at the surface (the position P1) than at the inner part (the position P2). To put it the other way around, the abundance of Al atoms is appropriately smaller at the inner part (the position P2) than at the surface (the position P1).

### (Physical Property Condition 3)

Regarding the concentration ratios X and Y described above, a relative ratio Z which is a ratio of the concentration ratio X to the concentration ratio Y (=concentration ratio X/concentration ratio Y) satisfies a condition represented by Expression (4) below.

1.30≤Z≤2.52 (4)

The relative ratio Z is a parameter indicating a magnitude relationship between the abundance of Al atoms at the position P1 and the abundance of Al atoms at the position P2. As is apparent from the condition indicated in Expression (4), the abundance of Al atoms gradually decreases from the surface (the position P1) toward the inner part (the position P2) in the positive electrode active material layer 21B, resulting in an appropriate concentration gradient regarding the abundance (atomic concentration) of Al atoms.

All of the physical property conditions 1 to 3 are satisfied for the following reason. This suppresses a decrease in discharge capacity and gas generation even upon repeated charging and discharging, and improves a lithium-ion entering and exiting characteristic not only at an initial charging and discharging cycle but also at subsequent charging and discharging cycles, while obtaining a high energy density. Details of the reason why all of the physical property conditions 1 to 3 are satisfied will be described later.

A procedure of analyzing the positive electrode active material layer 21B by XPS (a procedure of identifying each of the concentration ratios X and Y and the relative ratio Z) is as described below.

First, the secondary battery is discharged, following which the secondary battery is disassembled to thereby collect the positive electrode 21 (the positive electrode active material layer 21B). Thereafter, the positive electrode 21 is washed with pure water, following which the positive electrode 21 is dried. Thereafter, the positive electrode 21 is cut into a rectangular shape (10 mm×10 mm) to obtain a sample for analysis.

Thereafter, the sample is analyzed by means of an XPS analyzer. In this case, a scanning X-ray photoelectron spectrometer PHI Quantera SXM manufactured by ULVAC-PHI, Inc. is used as the XPS analyzer. Analysis conditions are set as follows. Light source: monochromatic Al Kα radiation (1486.6 eV), degree of vacuum: 1×10⁻⁹ Torr (=about 133.3×10⁻⁹ Pa), analysis range (diameter): 100 μm, analysis depth: several nanometers, and presence or absence of electron flood gun: present.

In this manner, the Ni2p3/2 spectrum and the Al2s spectrum are each detected at the surface (the position P1) of the positive electrode active material layer 21B, and the atomic concentration (at %) of Ni and the atomic concentration (at %) of Al are each calculated. The concentration ratio X is thereby calculated on the basis of the atomic concentration of Ni and the atomic concentration of Al.

Thereafter, the concentration ratio X calculation work described above is repeated 20 times, following which an average value of 20 values of the concentration ratio X is calculated to thereby obtain the final concentration ratio X, i.e., the concentration ratio X to be used to determine whether the physical property condition 1 is satisfied. The average value is used as the value of the concentration ratio X for the purpose of improving calculation accuracy (reproducibility) of the concentration ratio X.

Thereafter, an analysis procedure similar to the analysis procedure in the case where the concentration ratio X is calculated is performed, except that the analysis depth out of the analysis conditions is changed from several nanometers to 100 nm, and that new analysis conditions are set as follows. Acceleration voltage: 1 kV, and sputtering rate: within a range from 6 nm to 7 nm both inclusive in terms of SiO₂. In this manner, the atomic concentration (at %) of Ni and the atomic concentration (at %) of Al are each calculated at the inner part (the position P2) of the positive electrode active material layer 21B. The concentration ratio Y is thereby calculated on the basis of the atomic concentration of Ni and the atomic concentration of Al. In this case also, an average value is used as the value of the final concentration ratio Y to thereby improve calculation accuracy (reproducibility) of the concentration ratio Y.

Lastly, the relative ratio Z is calculated on the basis of the concentration ratios X and Y. The concentration ratios X and Y are each identified and the relative ratio Z is identified in this manner.

Upon charging the secondary battery, lithium is extracted from the positive electrode 21, and the extracted lithium is inserted into the negative electrode 22 via the electrolytic solution, in the battery device 20. Upon discharging the secondary battery, lithium is extracted from the negative electrode 22, and the extracted lithium is inserted into the positive electrode 21 via the electrolytic solution, in the battery device 20. Upon charging and discharging, lithium is inserted and extracted in an ionic state.

The positive electrode active material (the lithium-nickel composite oxide) is manufactured, following which the secondary battery is fabricated using the positive electrode active material.

In accordance with a procedure described below, the positive electrode active material (the lithium-nickel composite oxide) is manufactured by coprecipitation and firing including a single firing process.

First, as raw materials, a Ni source (a nickel compound) and a Co source (a cobalt compound) are prepared.

The nickel compound includes one or more of compounds including Ni as a constituent element. Specifically, the nickel compound is, for example, an oxide, a carbonic acid salt, a sulfuric acid salt, or a hydroxide. Details of the cobalt compound are similar to those of the nickel compound, except that the cobalt compound includes Co as a constituent element instead of Ni.

Thereafter, a mixture of the nickel compound and the cobalt compound is put into an aqueous solvent to thereby prepare a mixture aqueous solution. The aqueous solvent is not particularly limited in kind, and specific examples thereof include pure water. Details of the kind of the aqueous solvent described here apply also to the following. A mixture ratio between the nickel compound and the cobalt compound (the molar ratio between Ni and Co) may be freely chosen depending on the composition of the positive electrode active material (the lithium-nickel composite oxide) to be finally manufactured.

Thereafter, one or more of alkaline compounds are added to the mixture aqueous solution. The alkaline compound is not particularly limited in kind, and is specifically, for example, a hydroxide. A precipitate in a form of particles is thus formed, i.e., coprecipitation is performed. As a result, a precursor (secondary particles of a nickel-cobalt composite coprecipitated hydroxide) for synthesizing the lithium-nickel composite oxide is obtained. In this case, secondary particles of a bi-model design including two kinds of particles, i.e., large-sized particles and small-sized particles, may be used as will be described in detail in Examples below. Thereafter, the precursor is washed with an aqueous solvent.

Thereafter, as other raw materials, a Li source (a lithium compound) and an Al source (an aluminum compound) are prepared. In this case, a source of the additional element M (an additional compound) may be further prepared.

The lithium compound includes one or more of compounds including Li as a constituent element. Specifically, the lithium compound is, for example, an oxide, a carbonic acid salt, a sulfuric acid salt, or a hydroxide. Details of the aluminum compound are similar to those of the lithium compound, except that the aluminum compound includes Al as a constituent element instead of Li. Details of the additional compound are similar to those of the lithium compound, except that the additional compound includes the additional element M as a constituent element instead of Li.

Thereafter, the precursor, the lithium compound, and the aluminum compound are mixed with each other to thereby obtain a precursor mixture. In this case, the additional compound may further be mixed with, for example, the precursor to thereby obtain the precursor mixture including the additional compound. A mixture ratio between the precursor, the lithium compound, and the aluminum compound (a molar ratio between Ni, Co, Li, and Al) may be freely chosen depending on the composition of the positive electrode active material (the lithium-nickel composite oxide) to be finally manufactured. The same applies to a mixture ratio of the additional compound (the molar ratio of the additional element M).

Lastly, the precursor mixture is fired in an oxygen atmosphere, i.e., firing is performed. Conditions including, for example, a firing temperature and a firing time may be freely set. The precursor, the lithium compound, and the aluminum compound thus react with each other. In this manner, the lithium-nickel composite oxide including Li, Ni, Co, and Al as constituent elements is synthesized. As a result, the positive electrode active material (the lithium-nickel composite oxide) is obtained. Needless to say, in a case where the precursor mixture includes the additional compound, the positive electrode active material (the lithium-nickel composite oxide) further including the additional element M as a constituent element is obtained.

In this case, in the process of firing the precursor mixture, Al atoms in the aluminum compound are sufficiently diffused toward an inner part of the precursor. This results in the concentration gradient in which the abundance (atomic concentration) of Al atoms gradually decreases from the surface (the position P1) toward the inner part (the position P2).

In the case of manufacturing the positive electrode active material (the lithium-nickel composite oxide), it is possible to adjust each of the concentration ratios X and Y by changing a condition such as the firing temperature at the time of firing the precursor mixture. Accordingly, it is also possible to adjust the relative ratio Z.

The secondary battery is manufactured using the positive electrode active material (the lithium-nickel composite oxide) described above by a procedure described below.

The positive electrode active material (including the lithium-nickel composite oxide) is mixed with, for example, the positive electrode binder and the positive electrode conductor to thereby obtain a positive electrode mixture. Thereafter, the positive electrode mixture is put into a solvent such as an organic solvent to thereby prepare a paste positive electrode mixture slurry. Thereafter, the positive electrode mixture slurry is applied on each of the two opposed surfaces of the positive electrode current collector 21A to thereby form the positive electrode active material layer 21B. Note that the positive electrode active material layer 21B may be compression-molded by means of, for example, a roll pressing machine. In this case, the positive electrode active material layer 21B may be heated. The positive electrode active material layer 21B may be compression-molded multiple times. The positive electrode active material layer 21B is thus formed on each of the two opposed surfaces of the positive electrode current collector 21A. In this manner, the positive electrode 21 is fabricated.

The negative electrode 22 is fabricated by a procedure similar to the fabrication procedure of the positive electrode 21 described above. Specifically, the negative electrode active material (including the lithium-titanium composite oxide) is mixed with, for example, the negative electrode binder and the negative electrode conductor to thereby obtain a negative electrode mixture. Thereafter, the negative electrode mixture is put into a solvent such as an organic solvent to thereby prepare a paste negative electrode mixture slurry. Thereafter, the negative electrode mixture slurry is applied on each of the two opposed surfaces of the negative electrode current collector 22A to thereby form the negative electrode active material layer 22B. Needless to say, the negative electrode active material layer 22B may be compression-molded. The negative electrode active material layer 22B is thus formed on each of the two opposed surfaces of the negative electrode current collector 22A. In this manner, the negative electrode 22 is fabricated.

The electrolyte salt is put into the solvent including the carboxylic acid ester, following which another solvent (the dinitrile compound) is added to the solvent. The electrolyte salt is thereby dispersed or dissolved in the solvent. As a result, the electrolytic solution is prepared.

Note that, in the case of preparing the electrolytic solution, respective addition amounts of the dinitrile compound and the carboxylic acid ester are adjusted to make the molar ratio MR fall within the range from 1% to 4% both inclusive.

First, the positive electrode lead 31 is coupled to the positive electrode 21 (the positive electrode current collector 21A) by a method such as a welding method, and the negative electrode lead 32 is coupled to the negative electrode 22 (the negative electrode current collector 22A) by a method such as a welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body. The wound body has a configuration similar to that of the battery device 20 except that the positive electrode 21, the negative electrode 22, and the separator 23 are each not impregnated with the electrolytic solution. Thereafter, the wound body is pressed by means of, for example, a pressing machine to thereby shape the wound body into an elongated shape.

Thereafter, the wound body is placed inside the depression part 10U, following which the outer package film 10 is folded to thereby cause portions of the outer package film 10 to be opposed to each other. Thereafter, outer edges of two sides of the outer package film 10 (the fusion-bonding layer) opposed to each other are fusion-bonded to each other by a method such as a thermal-fusion-bonding method to thereby contain the wound body in the pouch-shaped outer package film 10.

Lastly, the electrolytic solution is injected into the pouch-shaped outer package film 10, following which the outer edges of the remaining one side of the outer package film 10 (the fusion-bonding layer) are fusion-bonded to each other by a method such as a thermal-fusion-bonding method. In this case, the sealing film 41 is interposed between the outer package film 10 and the positive electrode lead 31, and the sealing film 42 is interposed between the outer package film 10 and the negative electrode lead 32. The wound body is thereby impregnated with the electrolytic solution. Thus, the battery device 20 which is the wound electrode body is fabricated. In addition, the battery device 20 is sealed in the pouch-shaped outer package film 10. As a result, the secondary battery is assembled.

The assembled secondary battery is charged and discharged. Various conditions including, without limitation, an environment temperature, the number of times of charging and discharging (i.e., the number of cycles), and charging and discharging conditions may be freely set. A film is thereby formed on a surface of, for example, the negative electrode 22. This allows the secondary battery to be in an electrochemically stable state.

As a result, the secondary battery using the outer package film 10, i.e., the secondary battery of the laminated-film type is completed.

According to the secondary battery, the positive electrode 21 (the positive electrode active material layer 21B) includes the lithium-nickel composite oxide of the layered rock-salt type, the negative electrode 22 includes the lithium-titanium composite oxide, and the electrolytic solution includes the dinitrile compound and the carboxylic acid ester. In addition, the above-described condition is satisfied regarding the ratio (the capacity ratio CR) of the capacity of the positive electrode 21 to the capacity of the negative electrode 22, and the above-described conditions are satisfied regarding the analysis result (the concentration ratios X and Y and the relative ratio Z) on the positive electrode active material layer 21B obtained by XPS. Specifically, the capacity ratio CR is within the range from 100% to 120% both inclusive, the concentration ratio X satisfies 0.30≤X≤0.70 (the physical property condition 1), the concentration ratio Y satisfies 0.16≤Y≤0.37 (the physical property condition 2), and the relative ratio Z satisfies 1.30≤Z≤2.52 (the physical property condition 3).

In this case, the capacity ratio CR, the concentration ratios X and Y, and the relative ratio Z are each optimized in the case where the positive electrode 21 includes the lithium-nickel composite oxide, the negative electrode 22 includes the lithium-titanium composite oxide, and the electrolytic solution includes the dinitrile compound and the carboxylic acid ester. As a result, a series of advantages described below are achieved.

Firstly, the positive electrode active material (the lithium-nickel composite oxide) includes, as a main component, Ni which is a transition metal element. This makes it possible to obtain a high energy density.

Secondly, Al included as a constituent element in the lithium-nickel composite oxide is present as a pillar not contributing to an oxidation-reduction reaction in the layered rock-salt crystal structure (a transition metal layer). Accordingly, Al has a property of not being involved in charging and discharging reactions, while being able to suppress a change in crystal structure.

Here, because the physical property condition 1 is satisfied regarding the analysis result (the concentration ratio X) on the positive electrode active material layer 21B obtained by XPS, an appropriate and sufficient amount of Al atoms is present at the surface (the position P1) of the positive electrode active material layer 21B. In this case, upon charging and discharging (upon insertion and extraction of lithium ions), the crystal structure of the lithium-nickel composite oxide is prevented from easily changing in the vicinity of the surface of the positive electrode active material layer 21B, which prevents the positive electrode active material layer 21B from easily swelling and contracting. Note that examples of a change in the crystal structure of the lithium-nickel composite oxide include an unintentional Li extraction phenomenon. This prevents the positive electrode active material from easily cracking upon charging and discharging, which prevents a highly reactive fresh surface from easily appearing on the positive electrode active material. The electrolytic solution is thus prevented from being easily decomposed on the fresh surface of the positive electrode active material. As a result, the discharge capacity is prevented from easily decreasing even upon repeated charging and discharging, and gas is prevented from being easily generated due to a decomposition reaction of the electrolytic solution upon charging and discharging.

In this case, in particular, even if the secondary battery is used (charged and discharged or stored) in a high-temperature environment, the discharge capacity is sufficiently prevented from decreasing easily, and gas is sufficiently prevented from being generated easily. In addition, in the positive electrode active material, a resistive film is prevented from being easily formed as a result of the fresh surface being prevented from easily appearing, and a change in crystal structure (e.g., a structural change from a hexagonal crystal to a cubic crystal) which causes an increase in resistance is also prevented from easily occurring.

Thirdly, because the physical property condition 2 is satisfied regarding the analysis result (the concentration ratio Y) on the positive electrode active material layer 21B obtained by XPS, the abundance of Al atoms is appropriately and sufficiently smaller at the inner part (the position P2) of the positive electrode active material layer 21B than at the surface (the position P1). In this case, not only at the initial charging and discharging cycle but also at the subsequent charging and discharging cycles, it becomes easier for lithium ions to enter and exit a portion, of the positive electrode active material layer 21B, on the inner side relative to the vicinity of the surface, without being excessively influenced by Al atoms. This makes it easier for charging and discharging reactions to proceed smoothly and sufficiently. As a result, the energy density is secured, and it becomes easier for lithium ions to be stably and sufficiently inserted and extracted upon charging and discharging.

Fourthly, because the physical property condition 3 is satisfied regarding the analysis result (the relative ratio Z) on the positive electrode active material layer 21B obtained by XPS, in the positive electrode active material layer 21B, the abundance of Al atoms is appropriately smaller at the inner part (the position P2) than at the surface (the position P1). More specifically, the abundance of Al gradually decreases from the surface (the position P1) toward the inner part (the position P2), without decreasing abruptly. In this case, in the positive electrode active material layer 21B, an advantage related to a first action based on the physical property condition 1 described above and an advantage related to a second action based on the physical property condition 2 described above are achieved in balance. This prevents a trade-off relationship, allowing the two advantages to be effectively achieved, as compared with a case where the physical property condition 3 is not satisfied. The trade-off relationship is a relationship in which achievement of one of two advantages results in a failure to achieve the other.

Fifthly, because the electrolytic solution includes both the dinitrile compound and the carboxylic acid ester, the dinitrile compound improves oxidation-reduction resistance of the carboxylic acid ester. This greatly widens a potential window on the oxidation side, as compared with a case where the electrolytic solution includes only the carboxylic acid ester without including the dinitrile compound. Thus, even if the lithium-nickel composite oxide having a high property of oxidizing the electrolytic solution is used as the positive electrode active material, a decomposition reaction of the electrolytic solution (in particular, the carboxylic acid ester) is suppressed upon charging and discharging, which suppresses gas generation due to the decomposition reaction of the electrolytic solution in the positive electrode 21.

Sixthly, owing to the decomposition reaction of the electrolytic solution being suppressed in the positive electrode 21, even if the lithium-titanium composite oxide is used as the negative electrode active material, formation of a by-product with high reducibility due to the decomposition reaction of the electrolytic solution in the positive electrode 21 is suppressed. Thus, a reduction reaction of the by-product in the negative electrode 22 is suppressed, which suppresses gas generation due to the reduction reaction of the by-product.

Seventhly, owing to the dinitrile compound serving as the protective film, the negative electrode 22 may have a small thickness. This makes a concentration distribution of the electrolytic solution uniform inside the negative electrode 22 even upon large-current charging, which makes it easier for lithium ions to be inserted into and extracted from the negative electrode 22.

Based upon the above, even if the positive electrode 21 includes the lithium-nickel composite oxide and the negative electrode 22 includes the lithium-titanium composite oxide, the decrease in discharge capacity and the gas generation are suppressed even upon repeated charging and discharging, and the lithium-ion entering and exiting characteristic improves not only at the initial charging and discharging cycle but also at the subsequent charging and discharging cycles, while a high energy density is obtained. This makes it possible to obtain a superior battery characteristic.

In this case, in particular, using coprecipitation and firing including a single firing process as a method of manufacturing the positive electrode active material allows substantially all of the physical property conditions 1 to 3 to be satisfied, which makes it possible to improve the battery characteristic, unlike in a case of using coprecipitation and firing including two firing processes.

Specifically, as will be described in detail in Examples below, in the case of using coprecipitation and firing including two firing processes, in the positive electrode active material layer 21B, the abundance of Al atoms becomes smaller at the inner part (the position P2) than at the surface (the position P1), as in the case of using coprecipitation and firing including a single firing process. However, the abundance of Al atoms excessively increases at the surface (the position P1) and the abundance of Al atoms excessively decreases at the inner part (the position P2), which results in a failure to satisfy the physical property condition 1 and a failure to satisfy the physical property condition 2. Otherwise, the abundance of Al atoms decreases abruptly at the inner part (the position P2) relative to that at the surface (the position P1), which results in a failure to satisfy the physical property condition 3. Thus, not all of the physical property conditions 1 to 3 are satisfied, which results in the trade-off relationship. This makes it difficult to improve the battery characteristic.

In contrast, in the case of using coprecipitation and firing including a single firing process, in the positive electrode active material layer 21B, the abundance of Al atoms appropriately increases at the surface (the position P1) and the abundance of Al atoms appropriately decreases at the inner part (the position P2), unlike in the case of using coprecipitation and firing including two firing processes. This allows both the physical property conditions 1 and 2 to be satisfied. Moreover, the abundance of Al atoms gradually decreases from the surface (the position P1) toward the inner part (the position P2), which allows the physical property condition 3 to be satisfied. Thus, all of the physical property conditions 1 to 3 are satisfied, which overcomes the trade-off relationship. This makes it possible to improve the battery characteristic.

In addition, d in Formula (1) may satisfy d>0, and accordingly the lithium-nickel composite oxide may include the additional element M as a constituent element. This makes it easier for lithium ions to smoothly enter and exit the positive electrode active material (the lithium-nickel composite oxide) at the time of charging and discharging. Accordingly, it is possible to achieve higher effects.

The lithium-titanium composite oxide may include one or more of the compound represented by Formula (5), the compound represented by Formula (6), or the compound represented by Formula (7). This sufficiently suppresses the swelling of the secondary battery. Accordingly, it is possible to achieve higher effects.

The molar ratio MR may be within the range from 1% to 4% both inclusive. This allows the dinitrile compound to selectively coordinate to titanium in the lithium-titanium composite oxide to an extent that movement of lithium ions (a Li/Li⁺ charge transfer reaction) is not inhibited, at an interface between the negative electrode 22 (the lithium-titanium composite oxide) and the electrolytic solution. Thus, the dinitrile compound serves as a protective film that suppresses a reduction reaction of the electrolytic solution at a potential of 1.5 V or less versus a lithium reference electrode. This suppresses gas generation due to the reduction reaction of the electrolytic solution even if the capacity ratio CR is 100% or greater. This sufficiently suppresses the swelling of the secondary battery. Accordingly, it is possible to achieve higher effects.

The dinitrile compound may include, without limitation, succinonitrile, and the carboxylic acid ester may include, without limitation, ethyl propionate. This sufficiently suppresses the swelling of the secondary battery. Accordingly, it is possible to achieve higher effects. In this case, in particular, even if ethyl propionate which more easily generates gas due to a decomposition reaction than propyl propionate while having a higher ionic conductivity than propyl propionate is used, gas generation is suppressed by, for example, succinonitrile. This makes it possible to achieve both improvement of the lithium-ion entry performance and suppression of the swelling of the secondary battery.

The solvent of the electrolytic solution may include the carboxylic acid ester, and the content of the carboxylic acid ester in the solvent may be within the range from 50 wt % to 90 wt % both inclusive. This sufficiently suppresses a decomposition reaction of the carboxylic acid ester upon charging and discharging. Thus, gas generation due to the decomposition reaction of the carboxylic acid ester is also sufficiently suppressed. In other words, even if a large amount of the carboxylic acid ester (having a content within the range from 50 wt % to 90 wt % both inclusive in the solvent) is used, the gas generation due to the decomposition reaction of the carboxylic acid ester is suppressed by the dinitrile compound, which prevents the secondary battery from easily swelling. This sufficiently suppresses the swelling of the secondary battery. Accordingly, it is possible to achieve higher effects.

The secondary battery may include the outer package film 10 having flexibility and containing the positive electrode 21, the negative electrode 22, and the electrolytic solution. Also in a case where the flexible outer package film 10 is used which causes deformation (swelling) to be visually recognized easily, the swelling of the secondary battery is effectively suppressed. Accordingly, it is possible to achieve higher effects.

The secondary battery may include a lithium-ion secondary battery. This makes it possible to obtain a sufficient battery capacity stably through the use of insertion and extraction of lithium. Accordingly, it is possible to achieve higher effects.

Next, a description is given of modifications of the above-described secondary battery according to an embodiment.

The configuration of the secondary battery described above is appropriately modifiable as described below. Note that any two or more of the following series of modifications may be combined.

The separator 23 which is a porous film is used. However, although not specifically illustrated here, a separator of a stacked type including a polymer compound layer may be used instead of the separator 23 which is the porous film.

Specifically, the separator of the stacked type includes a porous film having two opposed surfaces, and a polymer compound layer provided on one of or each of the two opposed surfaces of the porous film. A reason for this is that adherence of the separator to each of the positive electrode 21 and the negative electrode 22 improves to suppress the occurrence of misalignment of the battery device 20 (irregular winding of each of the positive electrode 21, the negative electrode 22, and the separator). This helps to prevent the secondary battery from easily swelling even if, for example, a decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that such insulating particles dissipate heat upon heat generation by the secondary battery, thus improving safety or heat resistance of the secondary battery. Examples of the insulating particles include inorganic particles and resin particles. Specific examples of the inorganic particles include particles of aluminum oxide, aluminum nitride, boehmite, silicon oxide, titanium oxide, magnesium oxide, and zirconium oxide. Specific examples of the resin particles include particles of acrylic resin and styrene resin.

In a case of fabricating the separator of the stacked type, a precursor solution including, without limitation, the polymer compound and an organic solvent is prepared and thereafter the precursor solution is applied on one of or each of the two opposed surfaces of the porous film. In this case, the insulating particles may be added to the precursor solution on an as-needed basis.

Similar effects are obtainable also in the case where the separator of the stacked type is used, as lithium ions are movable between the positive electrode 21 and the negative electrode 22.

The electrolytic solution which is a liquid electrolyte is used. However, although not specifically illustrated here, an electrolyte layer which is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound in the electrolyte layer. A reason for this is that liquid leakage is prevented. The configuration of the electrolytic solution is as described above. The polymer compound includes, for example, polyvinylidene difluoride. In a case of forming the electrolyte layer, a precursor solution including, without limitation, the electrolytic solution, the polymer compound, and an organic solvent is prepared and thereafter the precursor solution is applied on one or both sides of the positive electrode 21 and one or both sides of the negative electrode 22.

Similar effects are obtainable also in the case where the electrolyte layer is used, as lithium ions are movable between the positive electrode 21 and the negative electrode 22 via the electrolyte layer.

Next, a description is given of applications (application examples) of the above-described secondary battery according to an embodiment.

The applications of the secondary battery are not particularly limited. The secondary battery used as a power source may serve as a main power source or an auxiliary power source of, for example, electronic equipment or an electric vehicle. The main power source is preferentially used regardless of the presence of any other power source. The auxiliary power source is used in place of the main power source, or is switched from the main power source.

Specific examples of the applications of the secondary battery include: electronic equipment including portable electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home or industrial battery systems for accumulation of electric power for a situation such as emergency. In these applications, one secondary battery or a plurality of secondary batteries may be used.

The battery pack may include a single battery, or may include an assembled battery. The electric vehicle is a vehicle that operates (travels) using the secondary battery as a driving power source, and may be a hybrid automobile that is additionally provided with a driving source other than the secondary battery as described above. An electric power storage system for home use allows, for example, home appliances to be used by utilizing electric power accumulated in the secondary battery which is an electric power storage source.

One of application examples of the secondary battery will now be described in detail. The configuration of the application example described below is merely an example, and is appropriately modifiable.

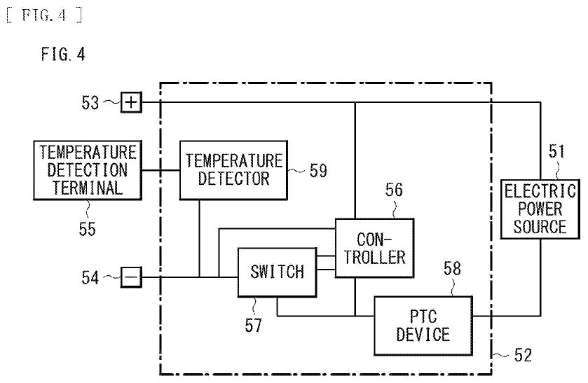

FIG. 4 illustrates a block configuration of a battery pack. The battery pack described here is a battery pack (a so-called soft pack) including one secondary battery, and is to be mounted on, for example, electronic equipment typified by a smartphone.

As illustrated in FIG. 4, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (a PTC device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51.

Is not particularly limited. For example, the overcharge detection voltage is 4.2 V±0.05 V and the overdischarge detection voltage is 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected on the basis of an ON-resistance of the switch 57.

The temperature detector 59 includes a temperature detection device such as a thermistor. The temperature detector 59 measures a temperature of the electric power source 51 using the temperature detection terminal 55, and outputs a result of the temperature measurement to the controller 56. The result of the temperature measurement to be obtained by the temperature detector 59 is used, for example, in a case where the controller 56 performs charge/discharge control upon abnormal heat generation or in a case where the controller 56 performs a correction process upon calculating a remaining capacity.

### EXAMPLES

A description is given of Examples of the present technology below according to an embodiment.

### Examples 1 to 8 and Comparative Examples 1 to 7

As described below, positive electrode active materials were manufactured, and secondary batteries were manufactured using the positive electrode active materials, following which the secondary batteries were evaluated for a battery characteristic.

### [Manufacture of Positive Electrode Active Materials in Examples 1 to 8 and Comparative Examples 1 to 6]

The positive electrode active material (the lithium-nickel composite oxide) was manufactured by, as the manufacturing method, coprecipitation and firing including a single firing process, in accordance with a procedure described below.

First, as raw materials, a nickel compound (nickel sulfate (NiSO₄)) in a powder form and a cobalt compound (cobalt sulfate (CoSO₄)) in a powder form were prepared. Thereafter, the nickel compound and the cobalt compound were mixed with each other to thereby obtain a mixture. In this case, the mixture ratio between the nickel compound and the cobalt compound was adjusted to set the mixture ratio (molar ratio) between Ni and Co to 85.4:14.6. The mixture ratio between the nickel compound and the cobalt compound was varied by varying the mixture ratio (molar ratio) of Co depending on the mixture ratio (molar ratio) of Ni.

Thereafter, the mixture was put into an aqueous solvent (pure water), following which the aqueous solvent was stirred to thereby obtain a mixture aqueous solution.

Thereafter, while the mixture aqueous solution was stirred, alkaline compounds (sodium hydroxide (NaOH) and ammonium hydroxide (NH₄OH)) were added into the mixture aqueous solution, i.e., coprecipitation was performed. A precipitate in a form of particles was thus formed in the mixture aqueous solution. As a result, a precursor (secondary particles of a nickel-cobalt composite coprecipitated hydroxide) was obtained. A composition of the precursor was as listed in Table 1. In this case, to finally obtain the secondary particles of the positive electrode active material having two different average particle sizes (median diameters D50 (μm)), that is, secondary particles of the bi-model design including large-sized particles and small-sized particles, the average particle sizes were controlled to thereby form two kinds of secondary particles having different average particle sizes.

Thereafter, as other raw materials, a lithium compound (lithium hydroxide monohydrate (LiOH.H₂O)) in a powder form and an aluminum compound (aluminum hydroxide (Al(OH)₃)) in a powder form were prepared.

Thereafter, the precursor, the aluminum compound, and the lithium compound were mixed with each other to thereby obtain a precursor mixture. In this case, a mixture ratio between the precursor and the aluminum compound was adjusted to set a mixture ratio (molar ratio) between Ni, Co, and Al to 82.0:14.0:4.0, and an addition amount (wt %) of the aluminum compound to the precursor was set to 1.12 wt %. In addition, a mixture ratio of the precursor and the aluminum compound to the lithium compound was adjusted to set a mixture ratio (molar ratio) of Ni, Co, and Al to Li to 103:100. Note that the mixture ratio between the precursor and the aluminum compound was varied by varying the mixture ratio (molar ratio) of Ni and Co depending on the mixture ratio (molar ratio) of Al. In addition, the mixture ratio of the precursor and the aluminum compound to the lithium compound was varied by varying the mixture ratio (molar ratio) of Ni, Co, and Al depending on the mixture ratio (molar ratio) of Li.

The “Addition timing” column in Table 1 indicates timing when the aluminum compound was added in a course of manufacturing the positive electrode active material. “After coprecipitation” indicates that the aluminum compound was added to the precursor after the precursor was obtained by coprecipitation before performing a firing process to be described later. In Table 1, the aluminum compound is presented as “Al compound” to simplify the presented contents.

Lastly, the precursor mixture was fired in an oxygen atmosphere. The firing temperature (° C.) was as listed in Table 1. Thus, the lithium-nickel composite oxide of the layered rock-salt type indicated in Formula (1) was synthesized in a powder form.

The “Number of times of firing” column in Table 1 indicates the number of firing processes performed in the course of manufacturing the positive electrode active material. Here, the number of times of firing was once, because the firing process was performed after the precursor was formed by coprecipitation.

In this manner, the positive electrode active material (the lithium-nickel composite oxide) was obtained. The composition and the NC ratio of the lithium-nickel composite oxide were as listed in Table 2. In Table 2, the lithium-nickel composite oxide is presented as “Li—Ni composite oxide” to simplify the presented contents.

In the case of manufacturing the positive electrode active material, the lithium-nickel composite oxide including, as a constituent element, manganese which is the additional element M was also synthesized by a similar procedure, except that a manganese compound (manganese sulfate (MnSO₄)) in a powder form was further prepared as another raw material, following which the manganese compound was further mixed with the precursor to thereby obtain the precursor mixture.

The “additional element M” column in Table 2 indicates presence or absence of the additional element M, and indicates, in a case where the lithium-nickel composite oxide included the additional element M as a constituent element, the kind of the additional element M. [Manufacture of Positive Electrode Active Material in Comparative Example 7]

For comparison, the positive electrode active material (the lithium-nickel composite oxide) was manufactured by, as the manufacturing method, coprecipitation and firing including two firing processes, instead of coprecipitation and firing including a single firing process, in accordance with a procedure described below.

In this case, in accordance with the procedure described above, the precursor (the secondary particles of the nickel-cobalt composite coprecipitated hydroxide) was first obtained by coprecipitation. Thereafter, a mixture of the precursor and the lithium compound (lithium hydroxide monohydrate) in a powder form was obtained, following which the mixture was fired (a first firing process). The mixture ratio (molar ratio) between the precursor and the lithium compound was as described above, and the firing temperature (° C.) in the first firing process was as listed in Table 1. Thus, a composite oxide in a powder form which is a fired body was obtained.

Thereafter, a mixture of the composite oxide and the aluminum compound (aluminum hydroxide) in a powder form was obtained, following which the mixture was fired (a second firing process) in an oxygen atmosphere. In this case, an addition amount of the aluminum compound to the composite oxide was set to 0.41 wt %. The firing temperature (° C.) in the second firing process was as listed in Table 1. Thus, a lithium-nickel composite oxide of a layered rock-salt type in a powder form (a lithium nickel cobalt oxide having a surface covered with Al) was synthesized. As a result, the positive electrode active material was obtained. The composition and the NC ratio of the lithium-nickel composite oxide were as listed in Table 2.

Here, the aluminum compound was added after the first firing process was performed, before performing the second firing process. The addition timing of the aluminum compound was thus after the first firing, as indicated in the “Addition timing” column in Table 1. Here, because two firing processes were performed as the method of manufacturing the positive electrode active material, the number of times of firing was twice, as indicated in the “Number of times of firing” column in Table 1.

TABLE 1

| | | | Al compound | | Firing process | |
|---|---|---|---|---|---|---|
| | | | | Addition | Number of | Firing |
| | Manufacturing | Precursor | Addition | amount | times of | temperature |
| | method | Composition | timing | (wt %) | firing | (° C.) |
| Example 1 | Coprecipitation + | (Ni_{0.854}Co_{0.146}) (OH)₂ | After | 1.12 | 1 | 700 |
| Example 2 | firing | (Ni_{0.854}Co_{0.146}) (OH)₂ | coprecipitation | 1.41 | | 700 |
| Example 3 | | (Ni_{0.854}Co_{0.146}) (OH)₂ | | 0.41 | | 700 |
| Example 4 | | (Ni_{0.854}Co_{0.146}) (OH)₂ | | 1.12 | | 650 |
| Example 5 | | (Ni_{0.854}Co_{0.146}) (OH)₂ | | 1.12 | | 850 |
| Example 6 | | (Ni_{0.812}Co_{0.188}) (OH)₂ | | 1.12 | | 700 |
| Example 7 | | (Ni_{0.937}Co_{0.063}) (OH)₂ | | 1.12 | | 700 |
| Example 8 | | (Ni_{0.833}Co_{0.083}Mn_{0.083}) (OH)₂ | | 1.12 | | 700 |
| Comparative example 1 | Coprecipitation + | (Ni_{0.854}Co_{0.146}) (OH)₂ | After | 1.56 | 1 | 700 |
| Comparative example 2 | firing | (Ni_{0.854}Co_{0.146}) (OH)₂ | coprecipitation | 0.27 | | 700 |
| Comparative example 3 | | (Ni_{0.854}Co_{0.146}) (OH)₂ | | 1.12 | | 600 |
| Comparative example 4 | | (Ni_{0.854}Co_{0.146}) (OH)₂ | | 1.12 | | 900 |
| Comparative example 5 | | (Ni_{0.781}Co_{0.219}) (OH)₂ | | 1.12 | | 700 |
| Comparative example 6 | | (Ni_{0.969}Co_{0.031}) (OH)₂ | | 1.12 | | 700 |
| Comparative example 7 | | (Ni_{0.854}Co_{0.146}) (OH)₂ | After first | 0.41 | 2 | First: 700 |
| | | | firing | | | Second: 650 |

TABLE 2
Negative electrode active material (Li₄Ti₅O₁₂ which is Li-Ti composite oxide), Capacity ratio CR =
110%, Dinitrile compound (SN), Molar ratio MR = 1%, Carboxylic acid ester (PrPr), Content = 75 wt %

| | | | | Positive electrode active | | | | | | |
|---|---|---|---|---|---|---|---|---|---|---|
| | Positive electrode active material | | | material layer | | | | | | |
| | (Li-Ni composite oxide) | | | Concen- | Concen- | | Initial | Cycle | Load | Swelling |
| | | NC | Additional | tration | tration | Relative | capacity | retention | retention | rate |
| | Composition | ratio | element M | ratio X | ratio Y | ratio Z | (—) | rate (%) | rate (%) | (—) |
| Example 1 | LiNi_{0.820}Co_{0.140}Al_{0.040}O₂ | 5.86 | — | 0.51 | 0.27 | 1.90 | 100 | 90 | 78 | 100 |
| Example 2 | LiNi_{0.811}Co_{0.139}Al_{0.050}O₂ | 5.83 | — | 0.70 | 0.37 | 1.87 | 99 | 94 | 75 | 90 |
| Example 3 | LiNi_{0.841}Co_{0.144}Al_{0.015}O₂ | 5.84 | — | 0.30 | 0.16 | 1.91 | 102 | 85 | 80 | 110 |
| Example 4 | LiNi_{0.820}Co_{0.140}Al_{0.040}O₂ | 5.86 | — | 0.57 | 0.23 | 2.52 | 97 | 92 | 79 | 101 |
| Example 5 | LiNi_{0.820}Co_{0.140}Al_{0.040}O₂ | 5.86 | — | 0.43 | 0.33 | 1.30 | 100 | 88 | 75 | 100 |
| Example 6 | LiNi_{0.780}Co_{0.180}Al_{0.040}O₂ | 4.33 | — | 0.52 | 0.28 | 1.89 | 96 | 92 | 77 | 100 |
| Example 7 | LiNi_{0.900}Co_{0.060}Al_{0.040}O₂ | 15.0 | — | 0.50 | 0.27 | 1.88 | 106 | 85 | 79 | 100 |
| Example 8 | LiNi_{0.800}Co_{0.080}Al_{0.040}Mn_{0.080}O₂ | 10.0 | Mn | 0.51 | 0.27 | 1.89 | 102 | 90 | 76 | 100 |
| Comparative | LiNi_{0.807}Co_{0.138}Al_{0.055}O₂ | 5.85 | — | 0.73 | 0.39 | 1.85 | 98 | 91 | 74 | 85 |
| example 1 | | | | | | | | | | |
| Comparative | LiNi_{0.846}Co_{0.144}Al_{0.010}O₂ | 5.88 | — | 0.28 | 0.14 | 1.94 | 103 | 83 | 81 | 113 |
| example 2 | | | | | | | | | | |
| Comparative | LiNi_{0.820}Co_{0.140}Al_{0.040}O₂ | 5.86 | — | 0.60 | 0.17 | 3.55 | 95 | 88 | 75 | 102 |
| example 3 | | | | | | | | | | |
| Comparative | LiNi_{0.820}Co_{0.140}Al_{0.040}O₂ | 5.86 | — | 0.40 | 0.32 | 1.25 | 100 | 85 | 74 | 100 |
| example 4 | | | | | | | | | | |
| Comparative | LiNi_{0.750}Co_{0.210}Al_{0.040}O₂ | 3.57 | — | 0.53 | 0.28 | 1.89 | 95 | 93 | 78 | 100 |
| example 5 | | | | | | | | | | |
| Comparative | LiNi_{0.930}Co_{0.030}Al_{0.040}O₂ | 31.0 | — | 0.49 | 0.26 | 1.91 | 108 | 81 | 79 | 100 |
| example 6 | | | | | | | | | | |
| Comparative | LiNi_{0.841}Co_{0.144}Al_{0.015}O₂ | 5.84 | — | 0.60 | 0.15 | 4.00 | 102 | 84 | 73 | 105 |
| example 7 | | | | | | | | | | |

### [Manufacture of Secondary Batteries in Examples 1 to 8 and Comparative Examples 1 to 7]

Secondary batteries (lithium-ion secondary batteries) of the laminated-film type illustrated in FIGS. 1 to 3 were manufactured by a procedure described below.

### (Fabrication of Positive Electrode)

First, 95.5 parts by mass of the positive electrode active material (the lithium-nickel composite oxide) was mixed with 1.9 parts by mass of the positive electrode binder (polyvinylidene difluoride), 2.5 parts by mass of the positive electrode conductor (carbon black), and 0.1 parts by mass of a dispersant (polyvinylpyrrolidone) to thereby obtain a positive electrode mixture. Thereafter, the positive electrode mixture was put into an organic solvent (N-methyl-2-pyrrolidone), following which the organic solvent was stirred to thereby prepare a paste positive electrode mixture slurry. Thereafter, the positive electrode mixture slurry was applied on each of the two opposed surfaces of the positive electrode current collector 21A (a band-shaped aluminum foil having a thickness of 15 pin) by means of a coating apparatus, following which the applied positive electrode mixture slurry was dried to thereby form the positive electrode active material layer 21B. Lastly, the positive electrode active material layer 21B was compression-molded by means of a roll pressing machine. In this manner, the positive electrode 21 was fabricated.

The result obtained by analyzing the physical property (the concentration ratios X and Y and the relative ratio Z) of the positive electrode 21 (the positive electrode active material layer 21B) by XPS was as listed in Table 2. Note that the procedure of analyzing the positive electrode active material layer 21B by XPS was as described above.

### (Fabrication of Negative Electrode)

First, 90 parts by mass of the negative electrode active material (Li₄Ti₅O₁₂ which is the lithium-titanium composite oxide) was mixed with 10 parts by mass of the negative electrode binder (polyvinylidene difluoride) to thereby obtain a negative electrode mixture. Thereafter, the negative electrode mixture was put into an organic solvent (N-methyl-2-pyrrolidone), following which the organic solvent was stirred to thereby prepare a paste negative electrode mixture slurry. Thereafter, the negative electrode mixture slurry was applied on each of the two opposed surfaces of the negative electrode current collector 22A (a band-shaped copper foil having a thickness of 15 μm) by means of a coating apparatus, following which the negative electrode mixture slurry was dried to thereby form the negative electrode active material layer 22B. Lastly, the negative electrode active material layer 22B was compression-molded by means of a roll pressing machine. In this manner, the negative electrode 22 was fabricated. In Table 2, the lithium-titanium composite oxide is presented as “Li—Ti composite oxide” to simplify the presented contents.

In particular, in the case of fabricating the negative electrode 22, the capacity ratio CR was set to 110% by adjusting the thickness (μm) of the negative electrode active material layer 22B depending on an application amount of the negative electrode mixture slurry, as indicated in Table 2.

### (Preparation of Electrolytic Solution)

First, the solvent was prepared. Used as the solvent was a mixture of propylene carbonate which is a cyclic carbonic acid ester and propyl propionate (PrPr) which is the carboxylic acid ester. In this case, the content of the carboxylic acid ester in the solvent was set to 75 wt %.

Thereafter, the electrolyte salt (LiPF₆ which is a lithium salt) was added to the solvent, following which the solvent was stirred. In this case, the content of the electrolyte salt with respect to the solvent was set to 1 mol/kg.

Lastly, the dinitrile compound (succinonitrile (SN)) was added to the solvent including the electrolyte salt, following which the solvent including the electrolyte salt was stirred. In this case, the molar ratio MR was set to 1% by adjusting the addition amount of the dinitrile compound.

Thus, the electrolyte salt and the dinitrile compound were each dissolved or dispersed in the solvent. As a result, the electrolytic solution was prepared.

### (Assembly of Secondary Battery)

First, the positive electrode lead 31 (a band-shaped aluminum foil) was welded to the positive electrode 21 (the positive electrode current collector 21A), and the negative electrode lead 32 (a band-shaped copper foil) was welded to the negative electrode 22 (the negative electrode current collector 22A).

Thereafter, the positive electrode 21 and the negative electrode 22 were stacked on each other with the separator 23 (a fine-porous polyethylene film having a thickness of 25 μm) interposed therebetween, following which the stack of the positive electrode 21, the negative electrode 22, and the separator 23 was wound to thereby fabricate the wound body. Thereafter, the wound body was pressed by means of a pressing machine, and was thereby shaped into an elongated shape.

Thereafter, the outer package film 10 was folded in such a manner as to sandwich the wound body placed in the depression 10U, following which the outer edges of two sides of the outer package film 10 (a fusion-bonding layer) were thermal-fusion-bonded to each other to thereby allow the wound body to be contained inside the pouch-shaped outer package film 10. As the outer package film 10, an aluminum laminated film was used in which the fusion-bonding layer (a polypropylene film having a thickness of 30 μm), a metal layer (an aluminum foil having a thickness of 40 μm), and a surface protective layer (a nylon film having a thickness of 25 μm) were stacked in this order from the inner side.

Lastly, the electrolytic solution was injected into the pouch-shaped outer package film 10 and thereafter, the outer edges of the remaining one side of the outer package film 10 (the fusion-bonding layer) were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32. The wound body was thereby impregnated with the electrolytic solution. Thus, the battery device 20 which is the wound electrode body was fabricated. In addition, the battery device 20 was sealed in the pouch-shaped outer package film 10. As a result, the secondary battery was assembled.

### (Stabilization of Secondary Battery)

The secondary battery was charged and discharged for one cycle in an ambient temperature environment (at a temperature of 25° C.). Upon charging, the secondary battery was charged with a constant current of 0.1 C until a voltage reached 4.2 V, and was thereafter charged with a constant voltage of that value of 4.2 V until a current reached 0.005 C. Upon discharging, the secondary battery was discharged with a constant current of 0.1 C until the voltage reached 2.5 V. Note that 0.1 C is a value of a current that causes the battery capacity (the theoretical capacity) to be completely discharged in 10 hours, and 0.005 C is a value of a current that causes the battery capacity to be completely discharged in 200 hours.

As a result, a film was formed on the surface of, for example, the negative electrode 22 to stabilize the state of the secondary battery. Thus, the secondary battery of the laminated-film type was completed.

Evaluation of the battery characteristic (an initial capacity characteristic, a cyclability characteristic, a load characteristic, and a swelling characteristic) of each of the secondary batteries revealed the results presented in Table 2.

The secondary battery was charged and discharged for one cycle in the ambient temperature environment to thereby measure the discharge capacity (an initial capacity). Charging and discharging conditions were similar to those in stabilizing the secondary battery described above. Note that the values of the initial capacity listed in Table 2 are normalized with respect to the value of the initial capacity of Example 1 assumed as 100.

First, the secondary battery was charged and discharged in a high-temperature environment (at a temperature of 60° C.) to thereby measure the discharge capacity (a first-cycle discharge capacity). Thereafter, the secondary battery was repeatedly charged and discharged in the same environment until the total number of cycles reached 100 to thereby measure the discharge capacity (a 100th-cycle discharge capacity). Charging and discharging conditions were similar to those in stabilizing the secondary battery described above. Lastly, cycle retention rate (%)=(100th-cycle discharge capacity/first-cycle discharge capacity)×100 was calculated.

First, the secondary battery was charged and discharged in the ambient temperature environment to thereby measure the discharge capacity (a first-cycle discharge capacity). Charging and discharging conditions were similar to those in stabilizing the secondary battery described above, except that the current at the time of charging and the current at the time of discharging were each changed from 0.1 C to 0.2 C. Thereafter, the secondary battery was charged and discharged again in the same environment to thereby measure the discharge capacity (a second-cycle discharge capacity). Charging and discharging conditions were similar to those in stabilizing the secondary battery described above, except that the current at the time of discharging was changed from 0.1 C to 10 C. Note that 0.2 C is a value of a current that causes the battery capacity to be completely discharged in 5 hours, and 10 C is a value of a current that causes the battery capacity to be completely discharged in 0.1 hours. Lastly, load retention rate (%)=(second-cycle discharge capacity (current at time of discharging=10 C)/first-cycle discharge capacity (current at time of discharging=0.2 C))×100 was calculated.

First, the secondary battery was charged in the ambient temperature environment, following which a volume (a pre-storage volume) of the secondary battery was measured by the Archimedes' method. Charging conditions were similar to those in stabilizing the secondary battery described above. Thereafter, the secondary battery was stored in the high-temperature environment for a storage period of 1 week, following which the volume (a post-storage volume) of the secondary battery was measured again by the Archimedes' method. Lastly, swelling rate (%)=(post-storage volume/pre-storage volume)×100 was calculated. Note that the values of the swelling rate indicated in Table 2 are normalized with respect to the value of the swelling rate of Example 1 assumed as 100.

As indicated in Table 2, the battery characteristic of the secondary battery varied depending on the analysis result (the concentration ratios X and Y and the relative ratio Z) on the positive electrode active material layer 21B obtained by XPS.

Specifically, in a case where not all of the physical property conditions 1 to 3 related to the concentration ratios X and Y and the relative ratio Z were satisfied (Comparative examples 1 to 7), a trade-off relationship was exhibited in which improvement of any of the initial capacity, the cycle retention rate, the load retention rate, and the swelling rate caused degradation of the others. This hindered improvement of each of the initial capacity, the cycle retention rate, the load retention rate, and the swelling rate.

In particular, in a case where the positive electrode active material (the lithium-nickel composite oxide) was manufactured by coprecipitation and firing including a single firing process (Comparative example 7), the relative ratio Z excessively increased, which resulted in a significant trade-off relationship described above.

In contrast, in a case where all of the physical property conditions 1 to 3 related to the concentration ratios X and Y and the relative ratio Z were satisfied (Examples 1 to 8), the trade-off relationship described above was overcome, which allowed for improvement of each of the initial capacity, the cycle retention rate, the load retention rate, and the swelling rate.

In this case, in particular, if the positive electrode active material (the lithium-nickel composite oxide) included the additional element M (Mn) as a constituent element, the load retention rate slightly decreased, but the initial capacity increased, as compared with a case where the lithium-nickel composite oxide did not include the additional element M as a constituent element. In addition, the swelling rate was sufficiently suppressed even if the flexible outer package film 10 which causes deformation (swelling) to be visually recognized easily was used.

### Examples 9 to 28 and Comparative Examples 8 to 14

As indicated in Tables 3 and 4, secondary batteries were fabricated by a similar procedure except that the capacity ratio CR (%) was changed, following which the secondary batteries were evaluated for the battery characteristic.

Here, in addition to the change of the capacity ratio CR, the kind of each of the dinitrile compound and the carboxylic acid ester, the molar ratio MR (%), and the content (wt %) of the carboxylic acid ester in the solvent were changed on an as-needed basis. In a case of changing the molar ratio MR, the addition amount of the dinitrile compound was changed. In a case of changing the content of the carboxylic acid ester in the solvent, the addition amount of the carboxylic acid ester was varied.

Alternatively used as the carboxylic acid ester were methyl propionate (MtPr), ethyl propionate (EtPr), methyl acetate (MtAc), and ethyl acetate (EtAc).

Alternatively used as the dinitrile compound were malononitrile (MN), glutaronitrile (GN), adiponitrile (AN), pimelonitrile (PN), and suberonitrile (SBN).

For comparison, the electrolytic solution was prepared by a similar procedure except that the dinitrile compound was not used.

In addition, for comparison, the electrolytic solution was prepared by a similar procedure except that a chain carbonic acid ester was used instead of the carboxylic acid ester. Diethyl carbonate (DEC) and ethyl methyl carbonate (EMC) were used as the chain carbonic acid ester.

In Table 4, for convenience, the chain carbonic acid ester (DEC and EMC) is indicated in the “Carboxylic acid ester” column. Note that an asterisk (*) is placed before each of DEC and EMC to clarify that each of DEC and EMC is not the carboxylic acid ester.

Further, for comparison, the negative electrode 22 was fabricated by a similar procedure except that a carbon material (graphite) was used as the negative electrode active material instead of the lithium-titanium composite oxide. A procedure of determining the capacity ratio CR in the case where the carbon material was used as the negative electrode active material was similar to the procedure of determining the capacity ratio CR in the case where the lithium-titanium composite oxide was used as the negative electrode active material, except that an upper-limit voltage at the time of charging was changed to 0 V and a lower-limit voltage at the time of discharging was changed to 1.5 V in a case of charging and discharging the test secondary battery to determine the capacity of the negative electrode 22.

In Table 4, for convenience, graphite is indicated in the “Negative electrode active material (Li—Ti composite oxide)” column. Note that an asterisk (*) is placed before graphite to clarify that graphite is not the Li—Ti composite oxide.

TABLE 3
Positive electrode active material (LiNi_{0.820}Co_{0.140}Al_{0.040}O₂ which is Li-Ni composite oxide), NC
ratio = 5.86, Concentration ratio X = 0.51, Concentration ratio Y = 0.27, Relative ratio Z = 1.90

| | Negative | | Dinitrile | | | | | | | |
|---|---|---|---|---|---|---|---|---|---|---|
| | electrode active | | compound | | Carboxylic acid | | | | | |
| | material (Li-Ti | Capacity | | Molar | ester | | Initial | Cycle | Load | Swelling |
| | composite oxide) | ratio | | ratio | | Content | capacity | retention | retention | rate |
| | Composition | CR (%) | Kind | MR (%) | Kind | (wt %) | (—) | rate (%) | rate (%) | (—) |
| Example 9 | Li₄Ti₅O₁₂ | 100 | SN | 1 | PrPr | 75 | 101 | 89 | 76 | 100 |
| Example 1 | Li₄Ti₅O₁₂ | 110 | SN | 1 | PrPr | 75 | 100 | 90 | 78 | 100 |
| Example 10 | Li₄Ti₅O₁₂ | 120 | SN | 1 | PrPr | 75 | 98 | 91 | 79 | 102 |
| Example 11 | Li₄Ti₅O₁₂ | 110 | SN | 2 | PrPr | 75 | 100 | 91 | 79 | 100 |
| Example 12 | Li₄Ti₅O₁₂ | 110 | SN | 3 | PrPr | 75 | 100 | 92 | 78 | 100 |
| Example 13 | Li₄Ti₅O₁₂ | 110 | SN | 4 | PrPr | 75 | 100 | 93 | 77 | 100 |
| Example 14 | Li₄Ti₅O₁₂ | 110 | SN | 5 | PrPr | 75 | 100 | 93 | 75 | 100 |
| Example 15 | Li₄Ti₅O₁₂ | 110 | SN | 10 | PrPr | 75 | 99 | 95 | 75 | 100 |
| Example 16 | Li₄Ti₅O₁₂ | 110 | SN | 1 | PrPr | 40 | 100 | 85 | 75 | 100 |
| Example 17 | Li₄Ti₅O₁₂ | 110 | SN | 1 | PrPr | 50 | 100 | 88 | 78 | 100 |
| Example 18 | Li₄Ti₅O₁₂ | 110 | SN | 1 | PrPr | 90 | 100 | 87 | 77 | 100 |
| Example 19 | Li₄Ti₅O₁₂ | 110 | SN | 1 | PrPr | 100 | 100 | 85 | 75 | 100 |
| Example 20 | Li₄Ti₅O₁₂ | 110 | MN | 1 | PrPr | 75 | 100 | 85 | 78 | 100 |
| Example 21 | Li₄Ti₅O₁₂ | 110 | GN | 1 | PrPr | 75 | 100 | 88 | 77 | 100 |
| Example 22 | Li₄Ti₅O₁₂ | 110 | AN | 1 | PrPr | 75 | 100 | 89 | 76 | 100 |

TABLE 4
Positive electrode active material (LiNi_{0.820}Co_{0.140}Al_{0.040}O₂ which is Li-Ni composite oxide), NC
ratio = 5.86, Concentration ratio X = 0.51, Concentration ratio Y = 0.27, Relative ratio Z = 1.90

| | Negative | | Dinitrile | | | | | | | |
|---|---|---|---|---|---|---|---|---|---|---|
| | electrode active | | compound | | Carboxylic acid | | | | | |
| | material (Li-Ti | Capacity | | Molar | ester | | Initial | Cycle | Load | Swelling |
| | composite oxide) | ratio | | ratio | | Content | capacity | retention | retention | rate |
| | Composition | CR (%) | Kind | MR (%) | Kind | (wt %) | (—) | rate (%) | rate (%) | (—) |
| Example 23 | Li₄Ti₅O₁₂ | 110 | PN | 1 | PrPr | 75 | 101 | 88 | 75 | 106 |
| Example 24 | Li₄Ti₅O₁₂ | 110 | SBN | 1 | PrPr | 75 | 100 | 87 | 73 | 108 |
| Example 25 | Li₄Ti₅O₁₂ | 110 | SN | 1 | MtPr | 75 | 100 | 87 | 74 | 102 |
| Example 26 | Li₄Ti₅O₁₂ | 110 | SN | 1 | EtPr | 75 | 100 | 89 | 75 | 100 |
| Example 27 | Li₄Ti₅O₁₂ | 110 | SN | 1 | MtAC | 75 | 100 | 85 | 77 | 109 |
| Example 28 | Li₄Ti₅O₁₂ | 110 | SN | 1 | EtAC | 75 | 100 | 87 | 78 | 107 |
| Comparative example 8 | Li₄Ti₅O₁₂ | 90 | SN | 1 | PrPr | 75 | 93 | 82 | 76 | 100 |
| Comparative example 9 | Li₄Ti₅O₁₂ | 130 | SN | 1 | PrPr | 75 | 92 | 91 | 74 | 100 |
| Comparative example 10 | Li₄Ti₅O₁₂ | 110 | — | 0 | PrPr | 75 | 100 | 87 | 77 | 121 |
| Comparative example 11 | Li₄Ti₅O₁₂ | 110 | — | 0 | *DEC | 75 | 100 | 90 | 76 | 123 |
| Comparative example 12 | Li₄Ti₅O₁₂ | 110 | — | 0 | *EMC | 75 | 100 | 91 | 75 | 119 |
| Comparative example 13 | *Graphite | 110 | — | 0 | PrPr | 75 | 201 | 73 | 64 | 112 |
| Comparative example 14 | *Graphite | 110 | SN | 1 | PrPr | 75 | 200 | 75 | 62 | 110 |

As indicated in Tables 3 and 4, even if all of the physical property conditions 1 to 3 related to the concentration ratios X and Y and the relative ratio Z were satisfied, the battery characteristic of the secondary battery varied further depending on the capacity ratio CR.

Specifically, in a case where the capacity ratio CR was less than 100% (Comparative example 8) and a case where the capacity ratio CR was greater than 120% (Comparative example 9), the trade-off relationship was exhibited, which hindered improvement of each of the initial capacity, the cycle retention rate, the load retention rate, and the swelling rate.

Also in a case where the electrolytic solution did not include the dinitrile compound and accordingly the molar ratio MR was 0% (Comparative example 10), the trade-off relationship was exhibited, which hindered improvement of each of the initial capacity, the cycle retention rate, the load retention rate, and the swelling rate.

In contrast, in a case where the capacity ratio CR was within the range from 100% to 120% both inclusive (Examples 1, 9, and 10), the trade-off relationship was overcome, which allowed for improvement of each of the initial capacity, the cycle retention rate, the load retention rate, and the swelling rate.

In particular, in a case where all of the physical property conditions 1 to 3 related to the concentration ratios X and Y and the relative ratio Z were satisfied and the capacity ratio CR was within the range from 100% to 120% both inclusive, tendencies described below were obtained.

Firstly, in a case where the molar ratio MR was within the range from 1% to 4% both inclusive (Examples 1 and 11 to 13), the load retention rate increased, as compared with a case where the molar ratio MR was greater than 4% (Examples 14 and 15).

Secondly, in a case where the content of the carboxylic acid ester in the solvent was within the range from 50 wt % to 90 wt % both inclusive (Example 1, 17, and 18), the cycle retention rate and the load retention rate each increased, as compared with a case where the content was less than 50 wt % (Example 16) and a case where the content was greater than 90 wt % (Example 19).

Thirdly, also in a case where the kind of the dinitrile compound was changed (Examples 20 to 24), the trade-off relationship was overcome, which allowed for improvement of each of the initial capacity, the cycle retention rate, the load retention rate, and the swelling rate. In this case, in particular, if succinonitrile, glutaronitrile, and adiponitrile were used as the dinitrile compound (Examples 1, 21, and 22), the cycle retention rate increased and the swelling rate decreased.

Fourthly, also in a case where the kind of the carboxylic acid ester was changed (Example 25 to 28), the trade-off relationship was overcome, which allowed for improvement of each of the initial capacity, the cycle retention rate, the load retention rate, and the swelling rate. In this case, in particular, if ethyl propionate and propyl propionate were used as the carboxylic acid ester (Examples 1 and 26), the cycle retention rate increased and the swelling rate decreased.

In a case where the carbon material was used as the negative electrode active material (Comparative examples 13 and 14), even if all of the physical property conditions 1 to 3 related to the concentration ratios X and Y and the relative ratio Z were satisfied and the appropriate condition was satisfied regarding the capacity ratio CR, the trade-off relationship was exhibited, which hindered improvement of each of the initial capacity, the cycle retention rate, the load retention rate, and the swelling rate.

In contrast, in a case where the lithium-titanium composite oxide was used as the negative electrode active material (e.g., Example 1), if all of the physical property conditions 1 to 3 related to the concentration ratios X and Y and the relative ratio Z were satisfied and the appropriate condition was satisfied regarding the capacity ratio CR, the trade-off relationship was overcome, which allowed for improvement of each of the initial capacity, the cycle retention rate, the load retention rate, and the swelling rate, as described above.

As described above,

Based upon the results presented in Tables 2 to 4, if the positive electrode 21 (the positive electrode active material layer 21B) included the lithium-nickel composite oxide of the layered rock-salt type, the negative electrode 22 included the lithium-titanium composite oxide, the electrolytic solution included the dinitrile compound and the carboxylic acid ester, and the series of conditions described above was satisfied regarding the ratio (the capacity ratio CR) of the capacity of the positive electrode 21 to the capacity of the negative electrode 22 and the analysis result (the concentration ratios X and Y and the relative ratio Z) on the positive electrode active material layer 21B obtained by XPS, the initial capacity, the cycle retention rate, the load retention rate, and the swelling rate were each improved. Accordingly, a superior battery characteristic (initial capacity characteristic, cyclability characteristic, load characteristic, and swelling characteristic) was obtained in the secondary battery.

Although the present technology has been described herein with reference to one or more embodiments including Examples, the configuration of the present technology is not limited to such description, and is therefore modifiable in a variety of suitable ways.

For example, the description has been given of the case where the secondary battery has a battery structure of the laminated-film type. However, the battery structure of the secondary battery is not particularly limited, and examples thereof may include a cylindrical type, a prismatic type, a coin type, and a button type.

Further, the description has been given of the case where the battery device has a device structure of the wound type. However, the device structure of the battery device is not particularly limited, and examples thereof may include a stacked type in which the electrodes (the positive electrode and the negative electrode) are stacked, and a zigzag folded type in which the electrodes (the positive electrode and the negative electrode) are each folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

Note that the applications of the positive electrode described above are not limited to the secondary battery. The positive electrode may be applied to another electrochemical device such as a capacitor.

The effects described herein are mere examples, and effects of the present technology are therefore not limited to those described herein. Accordingly, the present technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode including a positive electrode active material layer, the positive electrode active material layer including a lithium-nickel composite oxide of a layered rock-salt type represented by Formula (1) below;
a negative electrode including a lithium-titanium composite oxide; and
an electrolytic solution including a dinitrile compound and a carboxylic acid ester, wherein
a ratio of a capacity per unit area of the positive electrode to a capacity per unit area of the negative electrode is greater than or equal to 100 percent and less than or equal to 120 percent,
according to an analysis of the positive electrode active material layer performed at a surface of the positive electrode active material layer by X-ray photoelectron spectroscopy, a ratio X of an atomic concentration of Al to an atomic concentration of Ni satisfies a condition represented by Expression (2) below,
according to an analysis of the positive electrode active material layer performed at an inner part at a depth of 100 nanometers of the positive electrode active material layer by the X-ray photoelectron spectroscopy, a ratio Y of the atomic concentration of Al to the atomic concentration of Ni satisfies a condition represented by Expression (3) below, and
a ratio Z of the ratio X to the ratio Y satisfies a condition represented by Expression (4) below,
LiₐNi_{1-b-c-d}Co_{b}Al_{c}M_{d}Oₑ (1)
where
M is at least one of Fe, Mn, Cu, Zn, Cr, V, Ti, Mg, or Zr, and
a, b, c, d, and e satisfy 0.8<a<1.2, 0.06≤b≤0.18, 0.015≤c≤0.05, 0≤d≤0.08, 0<e<3, 0.1≤(b+c+d)≤0.22, and 4.33≤(1−b−c−d)/b≤15.0,
0.30≤X≤0.70 (2)
0.16≤Y≤0.37 (3)
1.30≤Z≤2.52 (4).

2. The secondary battery according to claim 1, wherein d in Formula (1) above satisfies d>0.

3. The secondary battery according to claim 1, wherein the lithium-titanium composite oxide includes at least one of a compound represented by Formula (5) below, a compound represented by Formula (6) below, or a compound represented by Formula (7) below,
Li[LiₓM1_{(1-3x)/2}Ti_{(3+x)/2}]O₄ (5)
where
M1 is at least one of Mg, Ca, Cu, Zn, or Sr, and
x satisfies 0≤x≤1/3,
Li[Li_{y}M2_{1-3y}Ti_{1+2y}]O₄ (6)
where
M2 is at least one of Al, Sc, Cr, Mn, Fe, Ga, or Y, and
y satisfies 0≤y≤1/3,
Li[Li_{1/3}M3_{z}Ti_{(5/3)-z}]O₄ (7)
where
M3 is at least one of V, Zr, or Nb, and
z satisfies 0≤z≤2/3.

4. The secondary battery according to claim 1, wherein a ratio of a number of moles of the dinitrile compound to a number of moles of the carboxylic acid ester is greater than or equal to 1 percent and less than or equal to 4 percent.

5. The secondary battery according to claim 1, wherein
the dinitrile compound includes at least one of succinonitrile, glutaronitrile, or adiponitrile, and
the carboxylic acid ester includes ethyl propionate, propyl propionate, or both.

6. The secondary battery according to claim 1, wherein
the electrolytic solution includes a solvent,
the solvent includes the carboxylic acid ester, and
a content of the carboxylic acid ester in the solvent is greater than or equal to 50 weight percent and less than or equal to 90 weight percent.

7. The secondary battery according to claim 1, further comprising an outer package member having flexibility and containing the positive electrode, the negative electrode, and the electrolytic solution.

8. The secondary battery according to claim 1, wherein the secondary battery comprises a lithium-ion secondary battery.
